(19) United States
(12) Patent Application Publication
(10) Pub. No.: US 2012/0029926 A1
(43) Pub. Date: Feb. 2, 2012

(54) SYSTEMS, METHODS, APPARATUS, AND COMPUTER-READABLE MEDIA FOR DEPENDENT-MODE CODING OF AUDIO SIGNALS

(75) Inventors: Venkatesh Krishnan, San Diego, CA (US); Vivek Rajendran, San Diego, CA (US); Ethan Robert Duni, San Diego, CA (US)

(73) Assignee: QUALCOMM Incorporated, San Diego, CA (US)

(21) Appl. No.: 13/193,542

(22) Filed: Jul. 28, 2011

Related U.S. Application Data
(60) Provisional application No. 61/369,662, filed on Jul. 30, 2010.
(60) Provisional application No. 61/369,705, filed on Jul. 31, 2010.
(60) Provisional application No. 61/369,751, filed on Aug. 1, 2010.
(60) Provisional application No. 61/374,565, filed on Aug. 17, 2010.
(60) Provisional application No. 61/384,237, filed on Sep. 17, 2010.
(60) Provisional application No. 61/470,438, filed on Mar. 31, 2011.

(51) Int. Cl. G10L 19/00

(52) U.S. Cl. 704/500; 704/E19.001

(57) ABSTRACT

A scheme for coding a set of transform coefficients that represent an audio-frequency range of a signal uses information from a reference frame that describes a previous frame of the signal to determine frequency-domain locations of regions of significant energy in a target frame of the signal.

### CLAIM OF PRIORITY UNDER 35 U.S.C. §119

The present Application for Patent claims priority to Provisional Application No. 61/369,662, entitled “SYSTEMS, METHODS, APPARATUS, AND COMPUTER-READABLE MEDIA FOR EFFICIENT TRANSFORM-DOMAIN CODING OF AUDIO SIGNALS,” filed Jul. 30, 2010. The present Application for Patent claims priority to Provisional Application No. 61/369,705, entitled “SYSTEMS, METHODS, APPARATUS, AND COMPUTER-READABLE MEDIA FOR DYNAMIC BIT ALLOCATION,” filed Jul. 31, 2010. The present Application for Patent claims priority to Provisional Application No. 61/369,751, entitled “SYSTEMS, METHODS, APPARATUS, AND COMPUTER-READABLE MEDIA FOR MULTI-STAGE SHAPE VECTOR QUANTIZATION,” filed Aug. 1, 2010. The present Application for Patent claims priority to Provisional Application No. 61/374,565, entitled “SYSTEMS, METHODS, APPARATUS, AND COMPUTER-READABLE MEDIA FOR GENERALIZED AUDIO CODING,” filed Aug. 17, 2010. The present Application for Patent claims priority to Provisional Application No. 61/384,237, entitled “SYSTEMS, METHODS, APPARATUS, AND COMPUTER-READABLE MEDIA FOR GENERALIZED AUDIO CODING,” filed Sep. 17, 2010. The present Application for Patent claims priority to Provisional Application No. 61/470,438, entitled “SYSTEMS, METHODS, APPARATUS, AND COMPUTER-READABLE MEDIA FOR DYNAMIC BIT ALLOCATION,” filed Mar. 31, 2011.

### BACKGROUND

1. Field

This disclosure relates to the field of audio signal processing.

2. Background

Coding schemes based on the modified discrete cosine transform (MDCT) are typically used for coding generalized audio signals, which may include speech and/or non-speech content, such as music. Examples of existing audio codecs that use MDCT coding include MPEG-1 Audio Layer 3 (MP3), Dolby Digital (Dolby Labs, London, UK; also called AC-3 and standardized as ATSC A/52), Vorbis (Xiph.Org Foundation, Somerville, Mass.), Windows Media Audio (WMA, Microsoft Corp., Redmond, Wash.), Adaptive Transform Acoustic Coding (ATRAC, Sony Corp., Tokyo, JP), and Advanced Audio Coding (AAC, as standardized most recently in ISO/IEC 14496-3:2009). MDCT coding is also a component of some telecommunications standards, such as Enhanced Variable Rate Codec (EVRC, as standardized in 3rd Generation Partnership Project 2 (3GPP2) document C.S0014-D v2.0, Jan. 25, 2010). The G.718 codec (“Frame error robust narrowband and wideband embedded variable bit-rate coding of speech and audio from 8-32 kbit/s,” Telecommunication Standardization Sector (ITU-T), Geneva, CH, June 2008, corrected November 2008 and August 2009, amended March 2009 and March 2010) is one example of a multi-layer codec that uses MDCT coding.

### SUMMARY

A method of audio signal processing according to a general configuration includes, in a frequency domain, locating a plurality of concentrations of energy in a reference frame that describes a frame of the audio signal. This method also includes, for each of the plurality of frequency-domain concentrations of energy, and based on a location of the concentration, selecting a location within a target frame of the audio signal for a corresponding one of a set of subbands of the target frame, wherein the target frame is subsequent in the audio signal to the frame that is described by the reference frame. This method also includes encoding the set of subbands of the target frame separately from samples of the target frame that are not in any of the set of subbands to obtain an encoded component. In this method, the encoded component includes, for each of at least one of the set of subbands, an indication of a distance in the frequency domain between the selected location for the subband and the location of the corresponding concentration. Computer-readable storage media (e.g., non-transitory media) having tangible features that cause a machine reading the features to perform such a method are also disclosed.

An apparatus for processing frames of an audio signal according to a general configuration includes means for locating, in a frequency domain, a plurality of concentrations of energy in a reference frame that describes a frame of the audio signal. This apparatus includes means for selecting, for each of the first plurality of frequency-domain concentrations of energy and based on a location of the concentration, a location within a target frame of the audio signal for a corresponding one of a set of subbands of the target frame, wherein the target frame is subsequent in the audio signal to the frame that is described by the reference frame. This apparatus includes means for encoding the set of subbands of the target frame separately from samples of the target frame that are not in any of the set of subbands to obtain an encoded component. In this apparatus, the encoded component includes, for each of at least one of the set of subbands, an indication of a distance in the frequency domain between the selected location for the subband and the location of the corresponding concentration.

An apparatus for processing frames of an audio signal according to another general configuration includes a locator configured to locate, in a frequency domain, a plurality of concentrations of energy in a reference frame that describes a frame of the audio signal. This apparatus includes a selector configured to select, for each of the first plurality of frequency-domain concentrations of energy and based on a location of the concentration, a location within a target frame of the audio signal for a corresponding one of a set of subbands of the target frame, wherein the target frame is subsequent in the audio signal to the frame that is described by the reference frame. This apparatus includes an encoder configured to encode the set of subbands of the target frame separately from samples of the target frame that are not in any of the set of subbands to obtain an encoded component. In this apparatus, the encoded component includes, for each of at least one of the set of subbands, an indication of a distance in the frequency domain between the selected location for the subband and the location of the corresponding concentration.

### BRIEF DESCRIPTION OF THE DRAWINGS

FIG. 1A shows a flowchart for a method MC100 of processing an audio signal according to a general configuration.

FIG. 1B shows a flowchart of an implementation MC110 of method MC100.

FIG. 2A illustrates an example of a peak selection window.

FIG. 2B shows an example of an operation of task TC200.

FIG. 2C shows an example of using a concatenated residual to fill the unoccupied bins on either side of a subband in order of increasing frequency.

FIG. 3 shows an example of reference and target frames of an MDCT-encoded signal.

FIG. 4A shows a flowchart of a method MD100 of decoding an encoded target frame.

FIG. 4B shows a flowchart of an implementation MD110 of method MD100.

FIG. 5 shows an example of encoding a target frame in which the subbands and the intervening regions of a residual are labeled.

FIG. 6 shows an example of encoding a portion of a residual signal as a number of unit pulses.

FIG. 7A shows a block diagram of an apparatus for audio signal processing MF100 according to a general configuration.

FIG. 7B shows a block diagram of an implementation MF110 of apparatus MF100.

FIG. 8A shows a block diagram of an apparatus for audio signal processing A100 according to another general configuration.

FIG. 8B shows a block diagram of an implementation 302 of encoder 300.

FIG. 8C shows a block diagram of an implementation A110 of apparatus A100.

FIG. 8D shows a block diagram of an implementation A120 of apparatus A110.

FIG. 8E shows a block diagram of an implementation A130 of apparatus A120.

FIG. 9A shows a block diagram of an implementation A140 of apparatus A110.

FIG. 9B shows a block diagram of an implementation A150 of apparatus A120.

FIG. 10A shows a block diagram of an apparatus for audio signal processing MFD100 according to a general configuration.

FIG. 10B shows a block diagram of an implementation MFD110 of apparatus MFD100.

FIG. 10C shows a block diagram of an apparatus for audio signal processing A100D according to another general configuration.

FIG. 11A shows a block diagram of an implementation A110D of apparatus A100D.

FIG. 11B shows a block diagram of an implementation A120D of apparatus A110D.

FIG. 11C shows a block diagram of an apparatus A200 according to a general configuration.

FIG. 12 shows a flowchart for a method MB110 of audio signal processing that may be performed in conjunction with method MC100.

FIG. 13 shows a plot of magnitude vs. frequency for an example in which a UB-MDCT signal is being modeled.

FIGS. 14A-E show a range of applications for various implementations of apparatus A120.

FIG. 15A shows a block diagram of a method MZ100 of signal classification.

FIG. 15B shows a block diagram of a communications device D10.

FIG. 16 shows front, rear, and side views of a handset H100.

### DETAILED DESCRIPTION

A dynamic subband selection scheme as described herein may be used to match perceptually important (e.g., high-energy) subbands of a frame to be encoded with corresponding perceptually important subbands of the previous frame.

It may be desirable to identify regions of significant energy within a signal to be encoded. Separating such regions from the rest of the signal enables targeted coding of these regions for increased coding efficiency. For example, it may be desirable to increase coding efficiency by using relatively more bits to encode such regions and relatively fewer bits (or even no bits) to encode other regions of the signal.

For audio signals having high harmonic content (e.g., music signals, voiced speech signals), the locations of regions of significant energy in the frequency domain at a given time may be relatively persistent over time. It may be desirable to perform efficient transform-domain coding of an audio signal by exploiting such a correlation over time.

A scheme as described herein for coding a set of transform coefficients that represent an audio-frequency range of a signal exploits time-persistence of energy distribution across the signal spectrum by encoding the locations of regions of significant energy in the frequency domain relative to locations of such regions in an earlier frame of the signal as decoded. In a particular application, such a scheme is used to encode MDCT transform coefficients corresponding to the 0-4 kHz range (henceforth referred to as the lowband MDCT, or LB-MDCT) of an audio signal, such as a residual of a linear prediction coding (LPC) operation.

Separating the locations of regions of significant energy from their content allows a representation of the locations of these regions to be transmitted to the decoder using minimal side information (e.g., offsets from the locations of those regions in a previous frame of the encoded signal). Such efficiency may be especially important for low-bit-rate applications, such as cellular telephony.

Unless expressly limited by its context, the term “signal” is used herein to indicate any of its ordinary meanings, including a state of a memory location (or set of memory locations) as expressed on a wire, bus, or other transmission medium. Unless expressly limited by its context, the term “generating” is used herein to indicate any of its ordinary meanings, such as computing or otherwise producing. Unless expressly limited by its context, the term “calculating” is used herein to indicate any of its ordinary meanings, such as computing, evaluating, smoothing, and/or selecting from a plurality of values. Unless expressly limited by its context, the term “obtaining” is used to indicate any of its ordinary meanings, such as calculating, deriving, receiving (e.g., from an external device), and/or retrieving (e.g., from an array of storage elements). Unless expressly limited by its context, the term “selecting” is used to indicate any of its ordinary meanings, such as identifying, indicating, applying, and/or using at least one, and fewer than all, of a set of two or more. Where the term “comprising” is used in the present description and claims, it does not exclude other elements or operations. The term “based on” (as in “A is based on B”) is used to indicate any of its ordinary meanings, including the cases (i) “derived from” (e.g., “B is a precursor of A”), (ii) “based on at least” (e.g., “A is based on at least B”) and, if appropriate in the particular context, (iii) “equal to” (e.g., “A is equal to B”). Similarly, the term “in response to” is used to indicate any of its ordinary meanings, including “in response to at least.”

Unless otherwise indicated, the term “series” is used to indicate a sequence of two or more items. The term “logarithm” is used to indicate the base-ten logarithm, although extensions of such an operation to other bases are within the scope of this disclosure. The term “frequency component” is used to indicate one among a set of frequencies or frequency bands of a signal, such as a sample of a frequency domain representation of the signal (e.g., as produced by a fast Fourier transform) or a subband of the signal (e.g., a Bark scale or mel scale subband).

Unless indicated otherwise, any disclosure of an operation of an apparatus having a particular feature is also expressly intended to disclose a method having an analogous feature (and vice versa), and any disclosure of an operation of an apparatus according to a particular configuration is also expressly intended to disclose a method according to an analogous configuration (and vice versa). The term “configuration” may be used in reference to a method, apparatus, and/or system as indicated by its particular context. The terms “method,” “process,” “procedure,” and “technique” are used generically and interchangeably unless otherwise indicated by the particular context. The terms “apparatus” and “device” are also used generically and interchangeably unless otherwise indicated by the particular context. The terms “element” and “module” are typically used to indicate a portion of a greater configuration. Unless expressly limited by its context, the term “system” is used herein to indicate any of its ordinary meanings, including “a group of elements that interact to serve a common purpose.” Any incorporation by reference of a portion of a document shall also be understood to incorporate definitions of terms or variables that are referenced within the portion, where such definitions appear elsewhere in the document, as well as any figures referenced in the incorporated portion.

The systems, methods, and apparatus described herein are generally applicable to coding representations of audio signals in a frequency domain. A typical example of such a representation is a series of transform coefficients in a transform domain. Examples of suitable transforms include discrete orthogonal transforms, such as sinusoidal unitary transforms. Examples of suitable sinusoidal unitary transforms include the discrete trigonometric transforms, which include without limitation discrete cosine transforms (DCTs), discrete sine transforms (DSTs), and the discrete Fourier transform (DFT). Other examples of suitable transforms include lapped versions of such transforms. A particular example of a suitable transform is the modified DCT (MDCT) introduced above.

Reference is made throughout this disclosure to a “lowband” and a “highband” (equivalently, “upper band”) of an audio frequency range, and to the particular example of a lowband of zero to four kilohertz (kHz) and a highband of 3.5 to seven kHz. It is expressly noted that the principles discussed herein are not limited to this particular example in any way, unless such a limit is explicitly stated. Other examples (again without limitation) of frequency ranges to which the application of these principles of encoding, decoding, allocation, quantization, and/or other processing is expressly contemplated and hereby disclosed include a lowband having a lower bound at any of 0, 25, 50, 100, 150, and 200 Hz and an upper bound at any of 3000, 3500, 4000, and 4500 Hz, and a highband having a lower bound at any of 3000, 3500, 4000, 4500, and 5000 Hz and an upper bound at any of 6000, 6500, 7000, 7500, 8000, 8500, and 9000 Hz. The application of such principles (again without limitation) to a highband having a lower bound at any of 3000, 3500, 4000, 4500, 5000, 5500, 6000, 6500, 7000, 7500, 8000, 8500, and 9000 Hz and an upper bound at any of 10, 10.5, 11, 11.5, 12, 12.5, 13, 13.5, 14, 14.5, 15, 15.5, and 16 kHz is also expressly contemplated and hereby disclosed. It is also expressly noted that although a highband signal will typically be converted to a lower sampling rate at an earlier stage of the coding process (e.g., via resampling and/or decimation), it remains a highband signal and the information it carries continues to represent the highband audio-frequency range.

A coding scheme as described herein may be applied to code any audio signal (e.g., including speech). Alternatively, it may be desirable to use such a coding scheme only for non-speech audio (e.g., music). In such case, the coding scheme may be used with a classification scheme to determine the type of content of each frame of the audio signal and select a suitable coding scheme.

A coding scheme as described herein may be used as a primary codec or as a layer or stage in a multi-layer or multi-stage codec. In one such example, such a coding scheme is used to code a portion of the frequency content of an audio signal (e.g., a lowband or a highband), and another coding scheme is used to code another portion of the frequency content of the signal. In another such example, such a coding scheme is used to code a residual (i.e., an error between the original and encoded signals) of another coding layer.

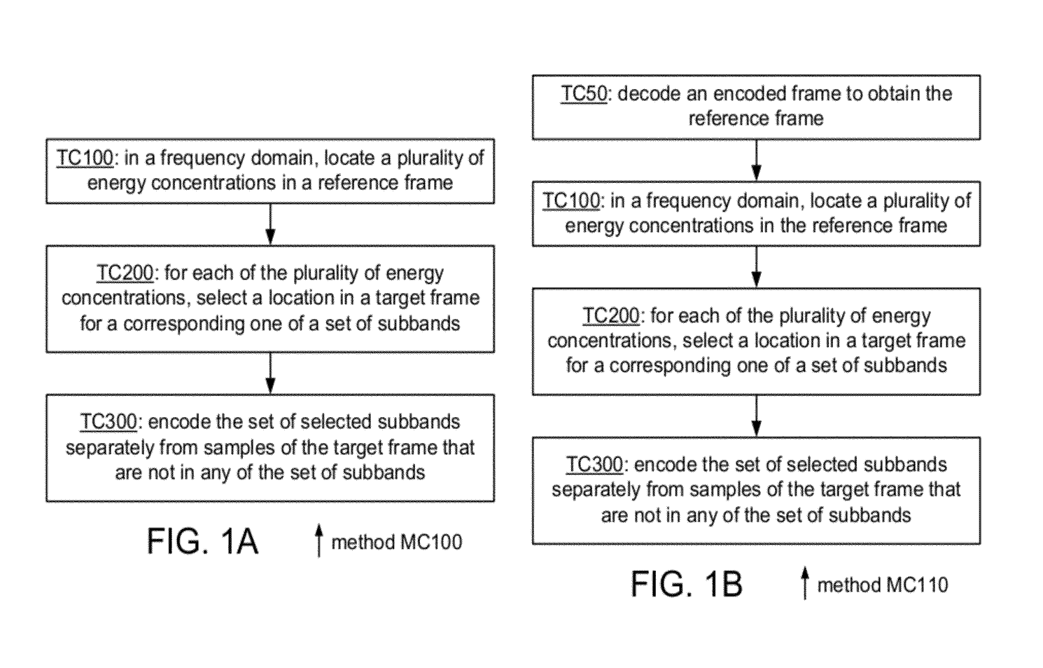

FIG. 1A shows a flowchart for a method MC100 of processing an audio signal according to a general configuration that includes tasks TC100, TC200, and TC300. Method MC100 may be configured to process the audio signal as a series of segments (e.g., by performing an instance of each of tasks TC100, TC200, and TC300 for each segment). A segment (or “frame”) may be a block of transform coefficients that corresponds to a time-domain segment with a length typically in the range of from about five or ten milliseconds to about forty or fifty milliseconds. The time-domain segments may be overlapping (e.g., with adjacent segments overlapping by 25% or 50%) or nonoverlapping.

It may be desirable to obtain both high quality and low delay in an audio coder. An audio coder may use a large frame size to obtain high quality, but unfortunately a large frame size typically causes a longer delay. Potential advantages of an audio encoder as described herein include high quality coding with short frame sizes (e.g., a twenty-millisecond frame size, with a ten-millisecond lookahead). In one particular example, the time-domain signal is divided into a series of twenty-millisecond nonoverlapping segments, and the MDCT for each frame is taken over a forty-millisecond window that overlaps each of the adjacent frames by ten milliseconds.

A segment as processed by method MC100 may also be a portion (e.g., a lowband or highband) of a block as produced by the transform, or a portion of a block as produced by a previous operation on such a block. In one particular example, each of a series of segments (or “frames”) processed by method MC100 contains a set of 160 MDCT coefficients that represent a lowband frequency range of 0 to 4 kHz. In another particular example, each of a series of frames processed by method MC100 contains a set of 140 MDCT coefficients that represent a highband frequency range of 3.5 to 7 kHz.

Task TC100 is configured to locate a plurality K of energy concentrations in a reference frame of the audio signal in a frequency domain. An “energy concentration” is defined as a sample (i.e., a peak), or a string of two or more consecutive samples (e.g., a subband), that has a high average energy per sample relative to the average energy per sample for the frame. The reference frame is a frame of the audio signal that has been quantized and dequantized. For example, the reference frame may have been quantized by an earlier instance of method MC100, although method MC100 is generally applicable regardless of the coding scheme that was used to encode and decode the reference frame.

For a case in which task TC100 is implemented to select the energy concentrations as subbands, it may be desirable to center each subband at the maximum sample within the subband. An implementation TC110 of task TC100 locates the energy concentrations as a plurality K of peaks in the decoded reference frame in a frequency domain, where a peak is defined as a sample of the frequency-domain signal (also called a “bin”) that is a local maximum. Such an operation may also be referred to as “peak-picking.”

It may be desirable to configure task TC100 to enforce a minimum distance between adjacent energy concentrations. For example, task TC110 may be configured to identify a peak as a sample that has the maximum value within some minimum distance to either side of the sample. In such case, task TC110 may be configured to identify a peak as the sample having the maximum value within a window of size (2dₘᵢₙ+1) that is centered at the sample, where dₘᵢₙ is a minimum allowed spacing between peaks.

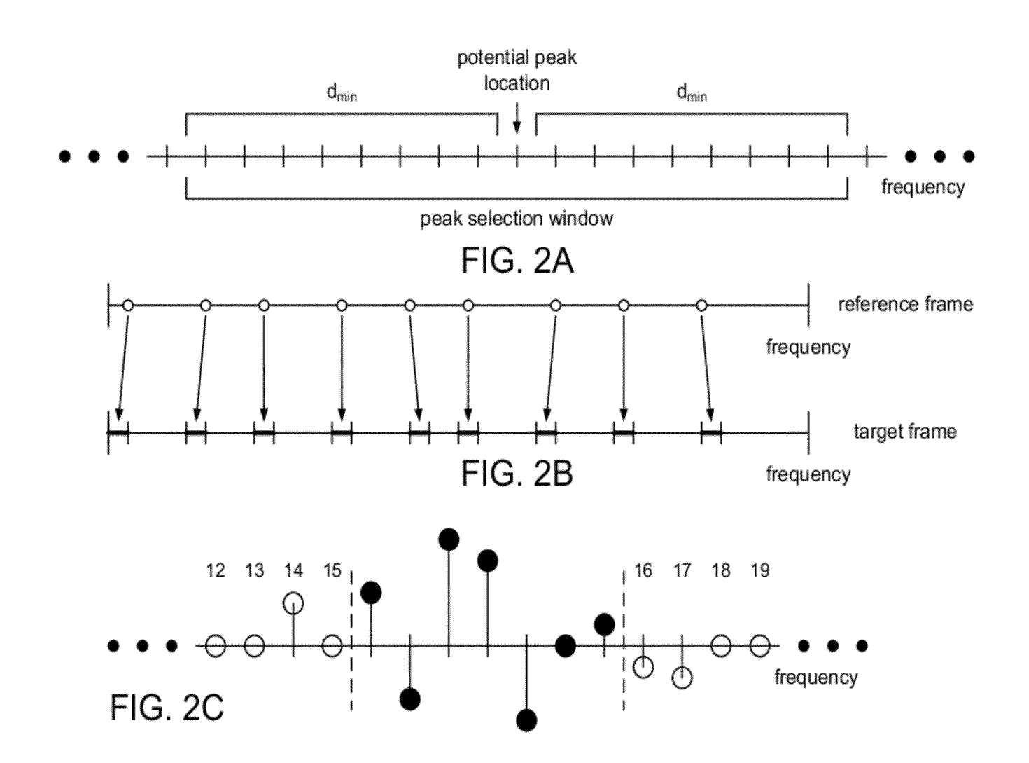

The value of dₘᵢₙ may be selected according to a maximum desired number of subbands to be located in the target frame, where this maximum may be related to the desired bit rate of the encoded target frame. It may be desirable to set a maximum limit on the number of peaks to be located (e.g., eighteen peaks per frame, for a frame size of 140 or 160 samples). Examples of dₘᵢₙ include four, five, six, seven, eight, nine, ten, twelve, and fifteen samples (alternatively, 100, 125, 150, 175, 200, or 250 Hz), although any value suitable for the desired application may be used. FIG. 2A illustrates an example of a peak selection window of size (2dₘᵢₙ+1), centered at a potential peak location of the reference frame, for a case in which the value of dₘᵢₙ is eight.

Task TC100 may be configured to enforce a minimum energy constraint on the located energy concentrations. In one such example, task TC110 is configured to identify a sample as a peak only if it has an energy greater than (alternatively, not less than) a specified proportion of the energy of the reference frame (e.g., two, three, four, or five percent). In another such example, task TC110 is configured to identify a sample as a peak only if it has an energy greater than (alternatively, not less than) an average sample energy of the reference frame (e.g., 400, 450, 500, 550, or 600 percent). It may be desirable to configure task TC100 (e.g., task TC110) to produce the plurality of energy concentrations as a list of locations that is sorted in order of decreasing energy (alternatively, in order of increasing or decreasing frequency).

For each of at least some of the plurality of energy concentrations located by task TC100, and based on a frequency-domain location of the energy concentration, task TC200 selects a location in a target frame for a corresponding one of a set of subbands of the target frame. The target frame is subsequent in the audio signal to the frame encoded by the reference frame, and typically the target frame is adjacent in the time domain to the frame encoded by the reference frame. For a case in which task TC100 is implemented to select the energy concentrations as subbands, it may be desirable to define the frequency-domain location of each concentration as the location of a center sample of the concentration. FIG. 2B shows an example of an operation of task TC200, where the circles indicate the locations of the energy concentrations in the reference frame, as determined by task TC100, and the brackets indicate the spans of the corresponding subbands in the target frame.

It may be desirable to implement method MC100 to accommodate changes in the energy spectrum of the audio signal over time. For example, it may be desirable to configure task TC200 to allow the selected location for a subband in the target frame (e.g., the location of a center sample of the subband) to differ somewhat from the location of the corresponding energy concentration in the reference frame. In such case, it may be desirable to implement task TC200 to allow the selected location for each of one or more of the subbands to deviate by a small number of bins in either direction (also called a shift or “jitter”) from the location indicated by the corresponding energy concentration. The value of such a shift or jitter may be selected, for example, so that the resulting subband captures more of the energy in the region.

Examples for the amount of jitter allowed for a subband include twenty-five, thirty, forty, and fifty percent of the subband width. The amount of jitter allowed in each direction of the frequency axis need not be equal. In a particular example, each subband has a width of seven bins and is allowed to shift its initial position along the frequency axis (e.g., as indicated by the location of the corresponding energy concentration of the reference frame) up to four frequency bins higher or up to three frequency bins lower. In this example, the selected jitter value for the subband may be expressed in three bits.

The shift value for a subband may be determined as the value which places the subband to capture the most energy. Alternatively, the shift value for a subband may be determined as the value which centers the maximum sample value within the subband. A peak-centering criterion tends to produce less variance among the shapes of the subbands, which may lead to more efficient coding by a vector quantization scheme as described herein. A maximum-energy criterion may increase entropy among the shapes by, for example, producing shapes that are not centered. In either case, it may be desirable to configure task TC200 to impose a constraint to prevent a subband from overlapping any subband whose location has already been selected for the target frame.

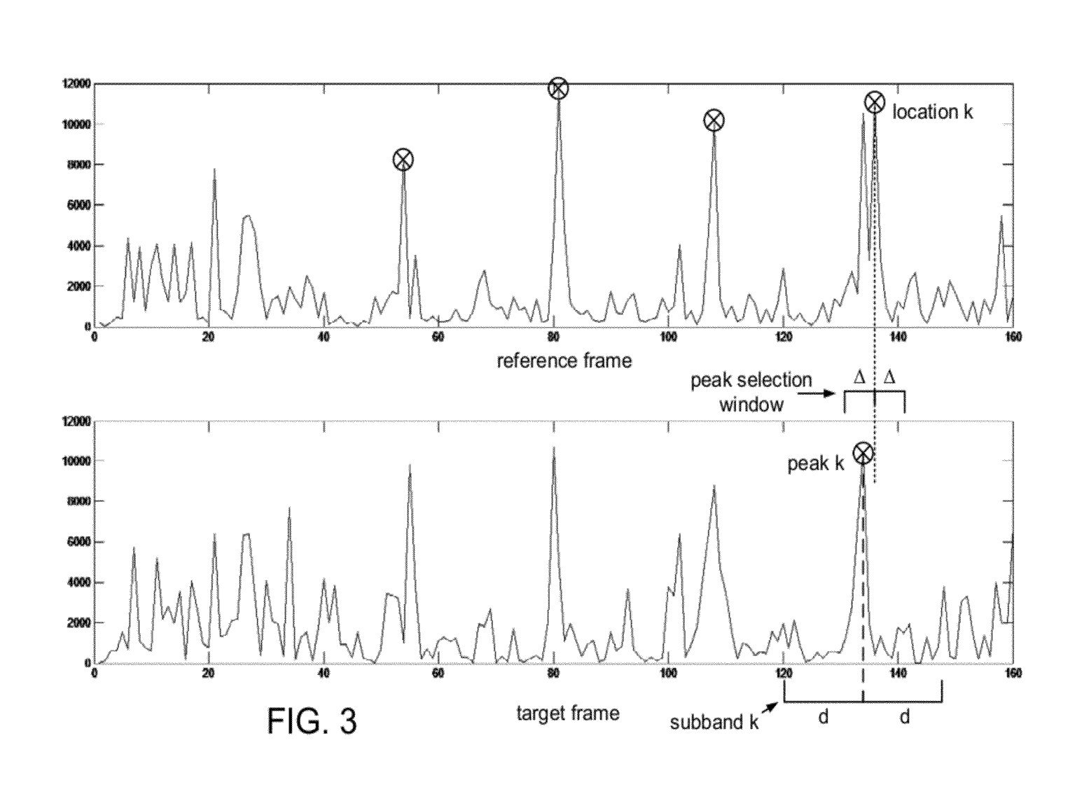

FIG. 3 shows an example of reference and target frames (top and bottom plots, respectively) of an MDCT-encoded signal in which the vertical axes indicate absolute sample value (i.e., sample magnitude) and the horizontal axes indicate frequency bin value. The targets in the top plot indicate locations of energy concentrations in the reference frame as determined by task TC100. As noted above, it may be desirable for task TC200 to receive the locations of the plurality of energy concentrations in the reference frame as a list that is sorted in order of decreasing energy (alternatively, in order of increasing or decreasing frequency). It may be desirable for the length of such a list to be at least as long as the maximum allowable number of subbands to be encoded for the target frame (e.g., eight, ten, twelve, fourteen, sixteen, or eighteen peaks per frame, for a frame size of 140 or 160 samples).

FIG. 3 also shows an example of an operation of an implementation TC202 of task TC200 on the target frame. Based on the frequency-domain locations of at least some of the K energy concentrations located by task TC100, task TC202 locates corresponding peaks in the target frame. The dotted line in FIG. 3 indicates the frequency-domain location in the target frame that corresponds to the location k in the reference frame.

Task TC202 may be implemented to locate each peak in the target frame by searching a window of the target frame that is centered at the location of the corresponding peak in the reference frame and has a width that is determined by the allowable range of jitter in each direction. For example, task T202 may be implemented to locate a corresponding peak in the target frame according to an allowable deviation of Δ bins in each direction from the location of the corresponding peak in the reference frame. Example values of Δ include two, three, four, five, six, seven, eight, nine, and ten (e.g., for a frame bandwidth of 140 or 160 bins). Within this peak selection window, as shown in FIG. 3, task TC202 may be configured to locate the peak as the sample of the target frame having the maximum energy (e.g., maximum magnitude) within the window.

Task TC300 encodes the set of subbands of the target frame that are indicated by the subband locations selected by task TC200. As shown in FIG. 3, task TC300 may be configured to select each subband as a string of samples of width (2d+1) bins that is centered at the corresponding location. Example values of d (which may be greater than, less than, or equal to Δ) include two, three, four, five, six, and seven (e.g., for a frame bandwidth of 140 or 160 bins).

Task TC300 may be implemented to encode subbands of fixed and equal length. In a particular example, each subband has a width of seven frequency bins (e.g., 175 Hz, for a bin spacing of twenty-five Hz). However, it is expressly contemplated and hereby disclosed that the principles described herein may also be applied to cases in which the lengths of the subbands may vary from one target frame to another, and/or in which the lengths of two or more (possibly all) of the set of subbands within a target frame may differ.

Task TC300 encodes the set of subbands separately from the other samples in the target frame (i.e., the samples whose locations on the frequency axis are before the first subband, between adjacent subbands, or after the last subband) to produce an encoded target frame. The encoded target frame indicates the contents of the set of subbands and also indicates the jitter value for each subband.

It may be desirable to implement task TC300 to use a vector quantization (VQ) coding scheme to encode the contents of the subbands (i.e., the values within each of the subbands) as vectors. A VQ scheme encodes a vector by matching it to an entry in each of one or more codebooks (which are also known to the decoder) and using the index or indices of these entries to represent the vector. The length of a codebook index, which determines the maximum number of entries in the codebook, may be any arbitrary integer that is deemed suitable for the application.

One example of a suitable VQ scheme is gain-shape VQ (GSVQ), in which the contents of each subband is decomposed into a normalized shape vector (which describes, for example, the shape of the subband along the frequency axis) and a corresponding gain factor, such that the shape vector and the gain factor are quantized separately. The number of bits allocated to encoding the shape vectors may be distributed uniformly among the shape vectors of the various subbands. Alternatively, it may be desirable to allocate more of the available bits to encoding shape vectors that capture more energy than others, such as shape vectors whose corresponding gain factors have relatively high values as compared to the gain factors of the shape vectors of other subbands (e.g., to allocate bits for shape coding based on the corresponding gain factors).

It may be desirable to implement task TC300 to use a GSVQ scheme that includes predictive gain coding such that the gain factors for each set of subbands are encoded independently from one another and differentially with respect to the corresponding gain factor of the previous frame. Additionally or alternatively, it may be desirable to implement task TC300 to encode the subband gain factors of a GSVQ scheme using a transform code. A particular example of method MC100 is implemented to use such a GSVQ scheme to encode regions of significant energy in a frequency range of an LB-MDCT spectrum of a target frame.

Alternatively, task TC300 may be implemented to encode the set of subbands using another coding scheme, such as a pulse-coding scheme. A pulse coding scheme encodes a vector by matching it to a pattern of unit pulses and using an index which identifies that pattern to represent the vector. Such a scheme may be configured, for example, to encode the number, positions, and signs of unit pulses in a concatenation of the subbands. Examples of pulse coding schemes include factorial-pulse-coding (FPC) schemes and combinatorial-pulse-coding (CPC) schemes. In a further alternative, task TC300 is implemented to use a VQ coding scheme (e.g., GSVQ) to encode a specified subset of the set of subbands and a pulse-coding scheme (e.g., FPC or CPC) to encode a concatenation of the remaining subbands of the set.

The encoded target frame also includes the jitter value calculated by task TC200 for each of the set of subbands. In one example, the jitter value for each of the set of subbands is stored to a corresponding element of a jitter vector, which may be VQ encoded before being packed by task TC300 into the encoded target frame. It may be desirable for the elements of the jitter vector to be sorted. For example, the elements of the jitter vector may be sorted according to the energy of the corresponding energy concentration (e.g., peak) of the reference frame (e.g., in decreasing order), or according to the frequency of the location of the corresponding energy concentration (e.g., in increasing or decreasing order), or according to a gain factor associated with the corresponding subband vector (e.g., in decreasing order). It may be desirable for the jitter vector to have a fixed length, in which case the vector may be padded with zeroes when the number of subbands to be encoded for a target frame is less than the maximum allowed number of subbands. Alternatively, the jitter vector may have a length that varies according to the number of subband locations that are selected by task TC200 for the target frame.

FIG. 1B shows a flowchart of an implementation MC110 of method MC100 that includes task TC50. Task TC50 decodes an encoded frame (e.g., an encoded version of the frame that immediately precedes the target frame in the signal being encoded) to obtain the reference frame. Task TC50 typically includes at least one dequantization operation. As noted herein, method MC100 is generally applicable regardless of the coding scheme that was used to produce the frame that is decoded by task TC50. Examples of decoding operations that may be performed by task TC50 include vector dequantization and inverse pulse coding. It is noted that task TC50 may be implemented to perform different respective decoding operations on different frames.

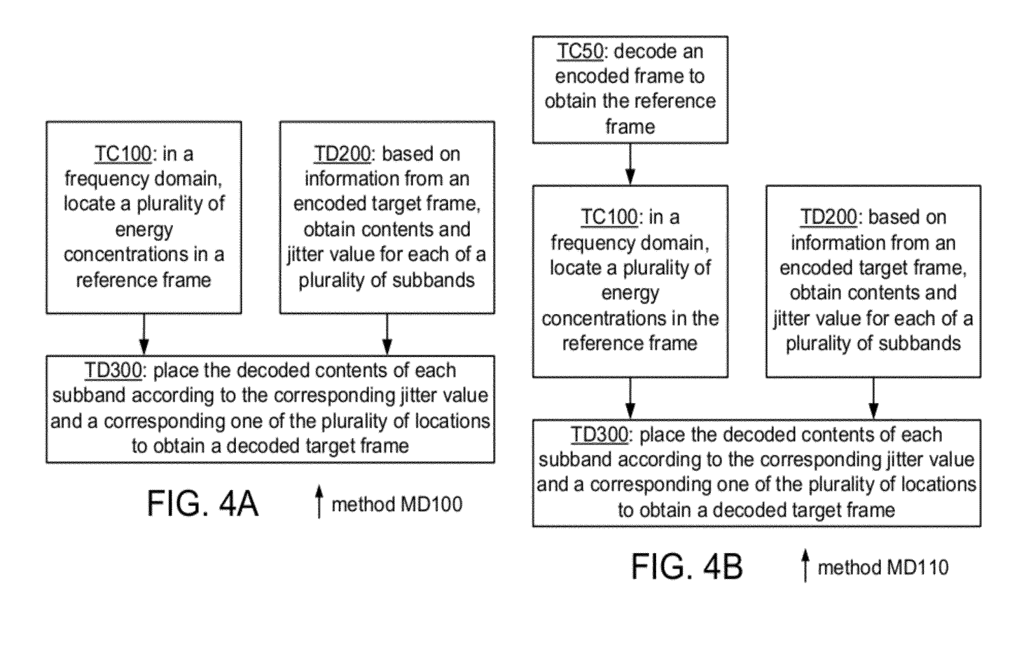

FIG. 4A shows a flowchart of a method MD100 of decoding an encoded target frame (e.g., as produced by method MC100) that includes an instance of task TC100 and tasks TD200 and TD300. The instance of task TC100 in method MD100 performs the same operation as the instance of task TC100 in the corresponding method MC100 as described herein. It is assumed that the encoded reference frame is received correctly at the decoder, such that both instances of task TC100 operate on the same input.

Based on information from an encoded target frame, task TD200 obtains the contents and jitter value for each of a plurality of subbands. For example, task TD200 may be implemented to perform the inverse of one or more quantization operations as described herein on a set of subbands and a corresponding jitter vector within the encoded target frame.

Task TD300 places the decoded contents of each subband, according to the corresponding jitter value and a corresponding one of the plurality of locations of energy concentrations (e.g., peaks) in the reference frame, to obtain a decoded target frame. For example, task TD300 may be implemented to construct the decoded target frame by centering the decoded contents of each subband k at the frequency-domain location pₖ+jₖ, where pₖ is the location of a corresponding peak in the reference frame and jₖ is the corresponding jitter value. Task TD300 may be implemented to assign zero values to unoccupied bins of the decoded target frame. Alternatively, task TD300 may be implemented to decode a residual signal as described herein that is separately encoded within the encoded target frame and to assign values of the decoded residual to unoccupied bins of the decoded signal. FIG. 4B shows a flowchart of an implementation MD110 of method MD100 that includes an instance of decoding task TC50, which performs the same operation as the instance of task TC50 in the corresponding method MC110 as described herein.

In some applications, it may be sufficient for the encoded target frame to include only the encoded set of subbands, such that the encoder discards signal energy that is outside of any of these subbands. In other cases, it may be desirable for the encoded target frame also to include a separate encoding of signal information that is not captured by the encoded set of subbands.

In one approach, a representation of the uncoded information (also called a residual signal) is calculated at the encoder by subtracting the reconstructed set of subbands from the original spectrum of the target frame. A residual calculated in such manner will typically have the same length as the target frame.

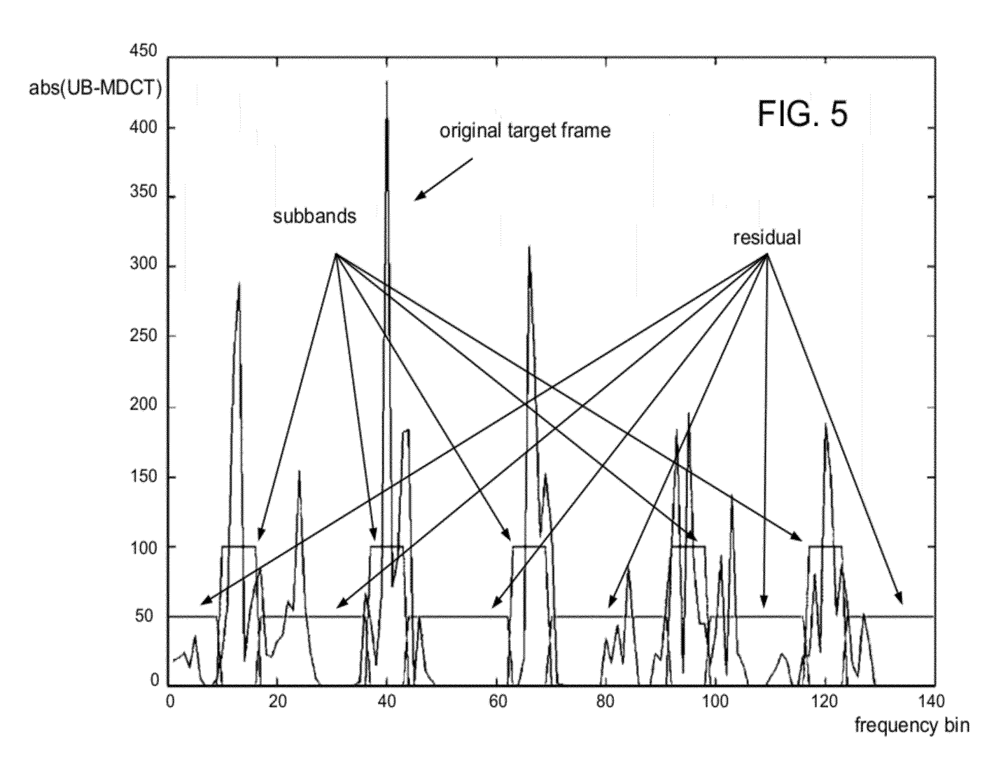

An alternative approach is to calculate the residual signal as a concatenation of the regions of the target frame that are not included in the set of subbands (i.e., bins whose locations on the frequency axis are before the first subband, between adjacent subbands, or after the last subband). A residual calculated in such manner has a length which is less than that of the target frame and which may vary from frame to frame (e.g., depending on the number of subbands in the encoded target frame). FIG. 5 shows an example of encoding the MDCT coefficients corresponding to the 3.5-7 kHz band of a target frame in which the subbands and the intervening regions of such a residual are labeled. As described herein, it may be desirable to use a pulse-coding scheme (e.g., factorial pulse coding) to encode such a residual.

FIG. 2C shows an example of using a concatenated residual to fill the unoccupied bins on either side of a subband in order of increasing frequency. In this example, the ordered elements 12-19 of the residual are arbitrarily selected to demonstrate filling the unoccupied bins in order of frequency up to one side of the subband and then continuing in order of frequency on the other side of the subband.

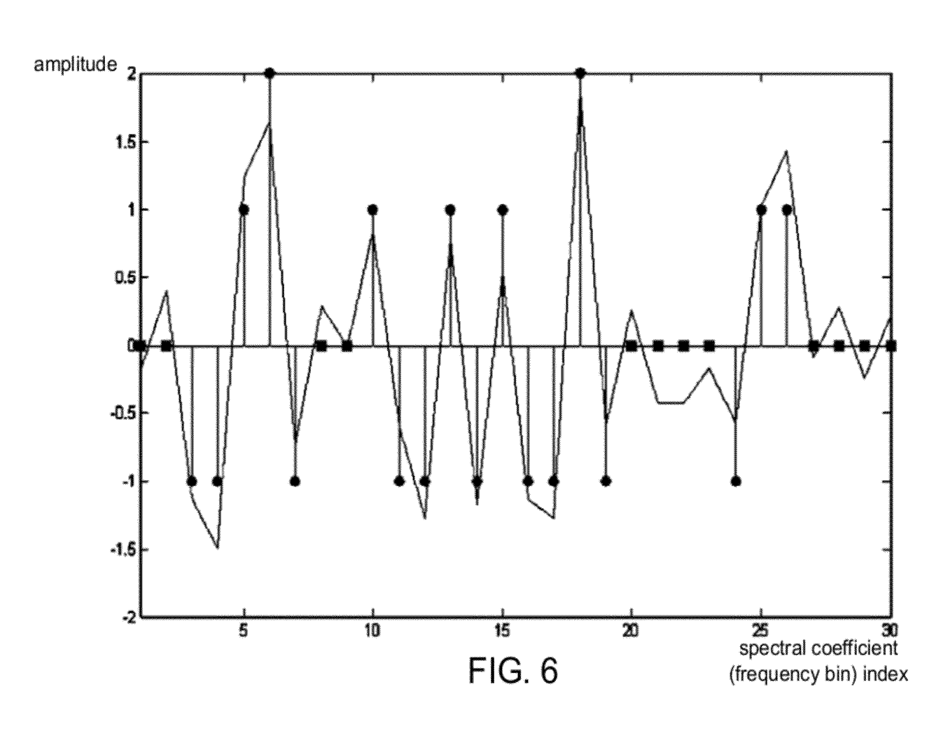

It may be desirable to use a pulse coding scheme (e.g., an FPC or CPC scheme) to code the residual signal. Such a scheme may be configured, for example, to encode the number, positions, and signs of unit pulses in the residual signal. FIG. 6 shows an example of such a method in which a portion of a residual signal is encoded as a number of unit pulses. In this example, a thirty-dimensional vector, whose value at each dimension is indicated by the solid line, is represented by the pattern of pulses (0, 0, −1, −1, +1, +2, −1, 0, 0, +1, −1, −1, +1, −1, +1, −1, −1, +2, −1, 0, 0, 0, 0, −1, +1, +1, 0, 0, 0, 0), as indicated by the dots (at pulse locations) and squares (at zero-value locations). A pattern of pulses as shown in FIG. 6, for example, can typically be represented by a codebook index whose length is much less than thirty bits.

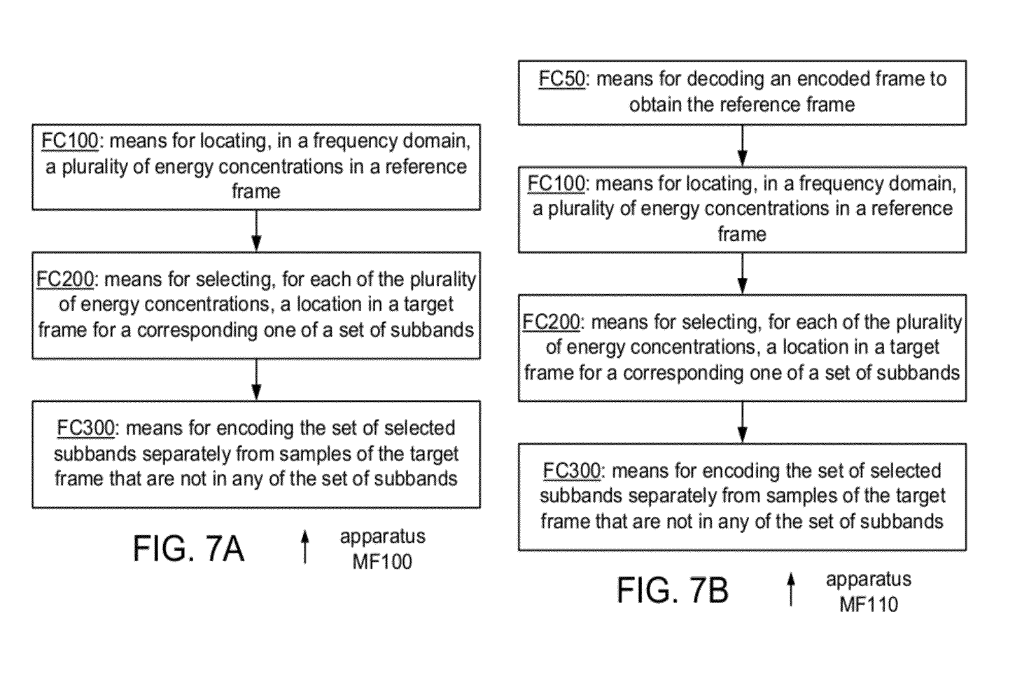

FIG. 7A shows a block diagram of an apparatus for audio signal processing MF100 according to a general configuration. Apparatus MF100 includes means FC100 for locating, in a frequency domain, a plurality of energy concentrations in a reference frame (e.g., as described herein with reference to task TC100). Apparatus MF100 also includes means FC200 for selecting, for each of the plurality of energy concentrations and based on a location of the concentration, a location in a target frame for a corresponding one of a set of subbands of the target frame, wherein the target frame is subsequent in an audio signal to a frame that is described by the reference frame (e.g., as described herein with reference to task TC200). Apparatus MF100 also includes means FC300 for encoding the set of selected subbands separately from samples of the target frame that are not in any of the set of subbands (e.g., as described herein with reference to task TC300). FIG. 7B shows a block diagram of an implementation MF110 of apparatus MF100 that also includes means FC50 for decoding an encoded frame to obtain the reference frame (e.g., as described herein with reference to task TC50).

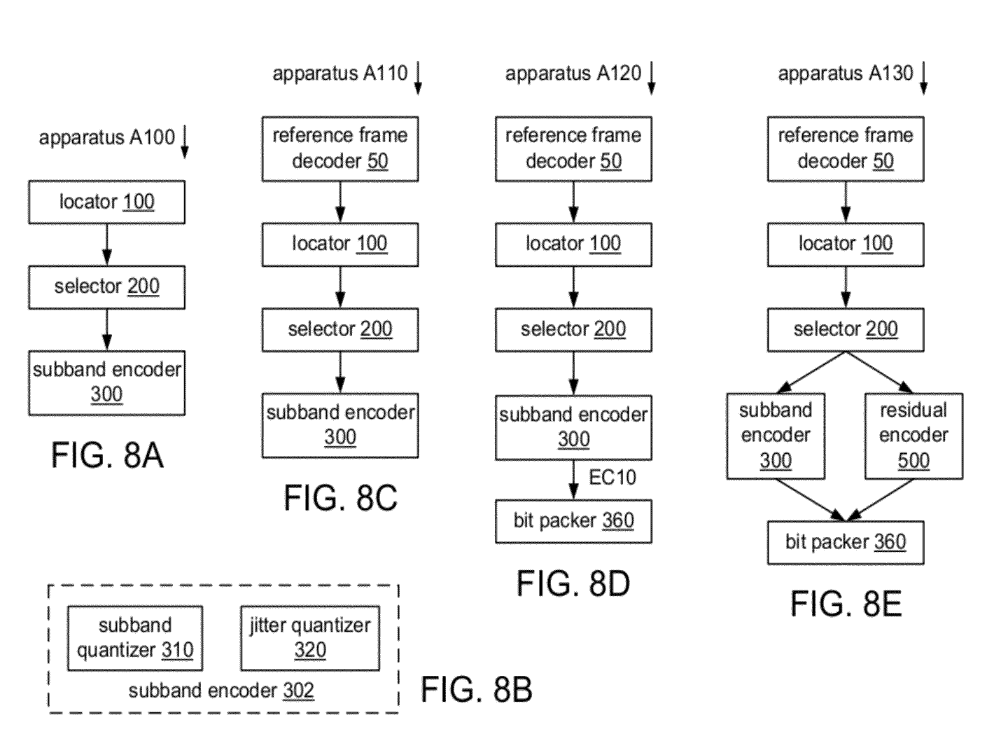

FIG. 8A shows a block diagram of an apparatus for audio signal processing A100 according to another general configuration. Apparatus A100 includes a locator 100 that is configured to locate, in a frequency domain, a plurality of energy concentrations in a reference frame (e.g., as described herein with reference to task TC100). Locator 100 may be implemented, for example, as a peak-picker (e.g., as described herein with reference to task TC110). Apparatus A100 also includes a selector 200 that is configured to select, for each of the plurality of energy concentrations and based on a location of the concentration, a location in a target frame for a corresponding one of a set of subbands of the target frame, wherein the target frame is subsequent in an audio signal to a frame that is described by the reference frame (e.g., as described herein with reference to task TC200). Apparatus A100 also includes a subband encoder 300 that is configured to encode the set of selected subbands separately from samples of the target frame that are not in any of the set of subbands (e.g., as described herein with reference to task TC300).

FIG. 8B shows a block diagram of an implementation 302 of subband encoder 300 that includes a subband quantizer 310 and a jitter quantizer 320. Subband quantizer 310 may be configured to encode the subbands as one or more vectors, using a GSVQ or other VQ scheme as described herein. Jitter quantizer 320 may also be configured to quantize the jitter values as a vector as described herein.

FIG. 8C shows a block diagram of an implementation A110 of apparatus A100 that includes a reference frame decoder 50. Decoder 50 is configured to decode an encoded frame to obtain the reference frame (e.g., as described herein with reference to task TC50). Decoder 50 may be implemented to include a frame storage that is configured to store the encoded frame to be decoded and/or a frame storage that is configured to store the decoded reference frame. As noted above, method MC00 is generally applicable regardless of the particular method that was used to encode the reference frame, and decoder 50 may be implemented to perform the inverse of any one or more encoding operations that may be in use in the particular application.

FIG. 8D shows a block diagram of an implementation A120 of apparatus A110 that includes a bit packer 360. Bit packer 360 is configured to pack the encoded component EC10 (i.e., the encoded subbands and corresponding encoded jitter values) produced by encoder 300 to produce an encoded frame.

FIG. 8E shows a block diagram of an implementation A130 of apparatus A120 that includes a residual encoder 500 configured to encode a residual of the target frame as described herein. In this example, residual encoder 500 is arranged to obtain the residual by concatenating the regions of the target frame that are not included in the set of subbands (e.g., as indicated by the subband locations produced by selector 200). Residual encoder 500 may be implemented to encode the residual using a pulse-coding scheme as described herein, such as FPC. In apparatus A130, bit packer 360 is arranged to pack the encoded residual produced by residual encoder 500 into the encoded frame that also includes the encoded component EC10 produced by subband encoder 300.

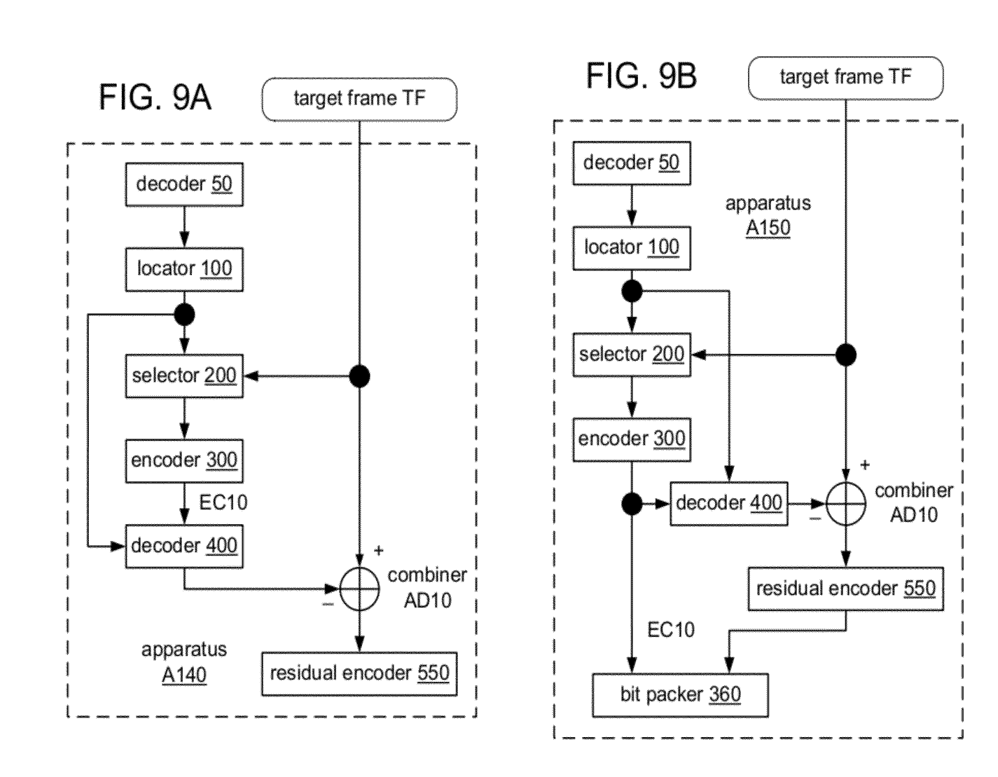

FIG. 9A shows a block diagram of an implementation A140 of apparatus A110 that includes a decoder 400, a combiner AD10 (e.g., an adder), and a residual encoder 550. Decoder 400 is configured to decode the encoded component produced by subband encoder 300 (e.g., as described herein with reference to method MD100). In this example, decoder 400 is implemented to receive the locations of the energy concentrations (e.g., peaks) from locator 100, rather than to repeat the same operation on the same reference frame, and to perform tasks MD200 and MD300 as described herein.

Combiner AD10 is configured to subtract the reconstructed set of subbands from the original spectrum of the target frame, and residual encoder 550 is arranged to encode the resulting residual. Residual encoder 550 may be implemented to encode the residual using a pulse-coding scheme as described herein, such as FPC. FIG. 9B shows a block diagram of a corresponding implementation A150 of apparatus A120 in which bit packer 360 is arranged to pack the encoded residual produced by residual encoder 550 into the encoded frame that also includes the encoded component EC10 produced by encoder 300.

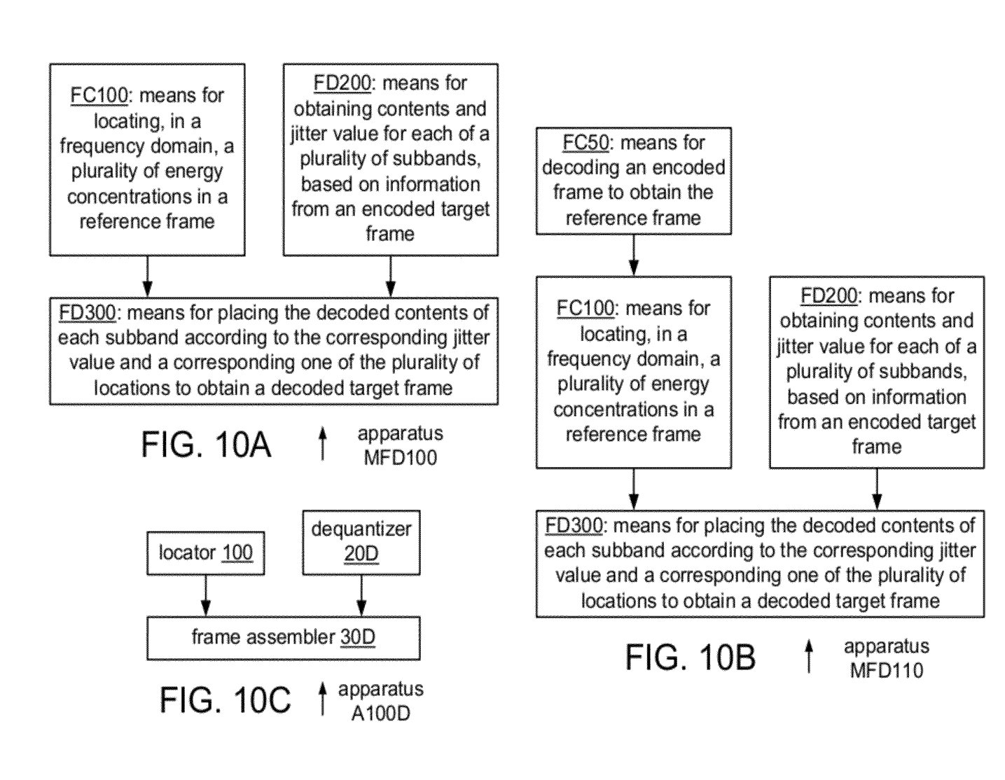

FIG. 10A shows a block diagram of an apparatus for audio signal processing MFD100 according to a general configuration. Apparatus MFD100 includes an instance of means FC100 for locating, in a frequency domain, a plurality of energy concentrations in a reference frame as described herein. Apparatus MFD100 also includes means FD200 for obtaining the contents and a jitter value for each of a plurality of subbands, based on information from an encoded target frame (e.g., as described herein with reference to task TD200). Apparatus MFD100 also includes means FD300 for placing the decoded contents of each of the plurality of subbands, according to the corresponding jitter value and a corresponding one of the plurality of frequency-domain locations, to obtain a decoded target frame (e.g., as described herein with reference to task TD300). FIG. 10B shows a block diagram of an implementation MFD110 of apparatus MFD100 that also includes an instance of means FC50 for decoding an encoded frame to obtain the reference frame as described herein.

FIG. 10C shows a block diagram of an apparatus for audio signal processing A100D according to another general configuration. Apparatus A100D includes an instance of locator 100 that is configured to locate, in a frequency domain, a plurality of energy concentrations in a reference frame as described herein. Apparatus A100D also includes a dequantizer 20D that is configured to decode information from an encoded target frame (e.g., the encoded component EC10) to obtain a decoded contents and a jitter value for each of a plurality of subbands (e.g., as described herein with reference to task TD200). (In one example, dequantizer 20D includes a subband dequantizer and a jitter dequantizer.) Apparatus A100D also includes a frame assembler 30D that is configured to place the decoded contents of each of the plurality of subbands, according to the corresponding jitter value and a corresponding one of the plurality of frequency-domain locations, to obtain a decoded target frame (e.g., as described herein with reference to task TD300).

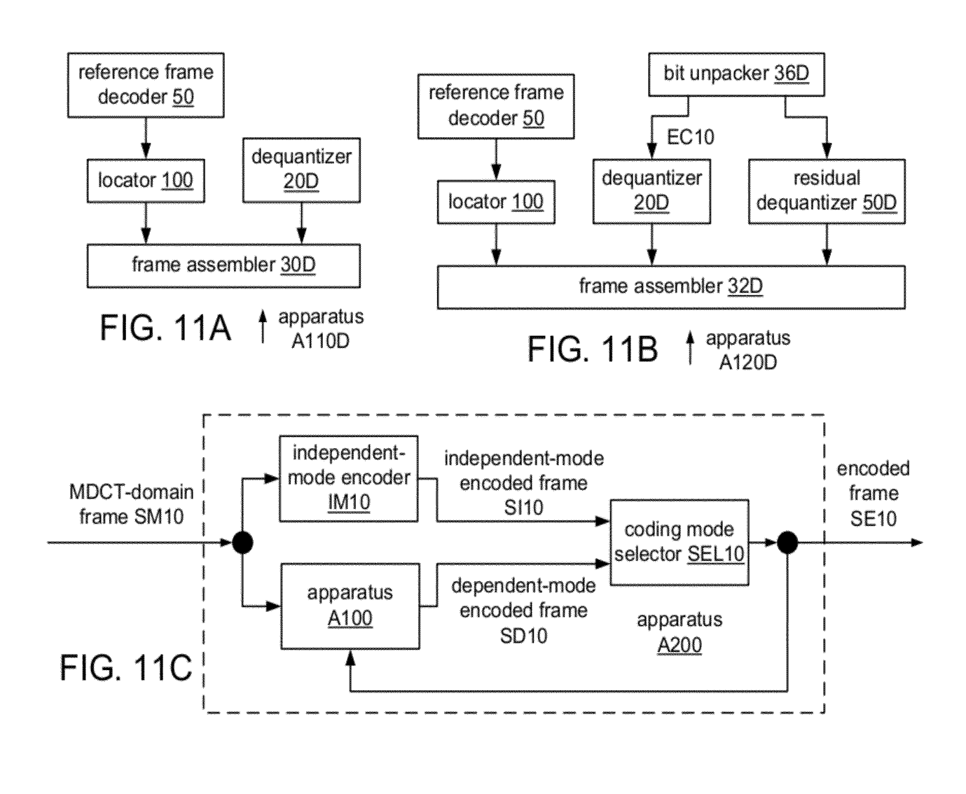

FIG. 11A shows a block diagram of an implementation A110D of apparatus A100D that also includes an instance of reference frame decoder 50 that is configured to decode an encoded frame to obtain the reference frame as described herein. FIG. 11B shows a block diagram of an implementation A120D of apparatus A110D that includes a bit unpacker 36D that is configured to unpack the encoded frame to produce the encoded component EC10 and an encoded residual. Apparatus A120D also includes a residual dequantizer 50D that is configured to dequantize the encoded residual and an implementation 32D of frame dequantizer 32D that is configured to place the decoded residual along with the decoded contents of the subbands to obtain the decoded frame. For a case in which the residual is calculated by subtracting the decoded subbands from the target frame, assembler 32D may be implemented to add the decoded residual to the decoded and placed subbands. For a case in which the residual is a concatenation of samples not included in the subbands, assembler 32D may be implemented to use the decoded residual to fill the bins of the frame that are not occupied by the decoded subbands (e.g., in order of increasing frequency).

FIG. 11C shows a block diagram of an apparatus A200 according to a general configuration, which is configured to receive frames of an audio signal (e.g., an LPC residual) as samples in a transform domain (e.g., as transform coefficients, such as MDCT coefficients or FFT coefficients). Apparatus A200 includes an independent-mode encoder IM10 that is configured to encode a frame SM10 of a transform-domain signal according to an independent coding mode to produce an independent-mode encoded frame SI10. For example, encoder IM10 may be implemented to encode the frame by grouping the transform coefficients into a set of subbands according to a predetermined division scheme (i.e., a fixed division scheme that is known to the decoder before the frame is received) and encoding each subband using a vector quantization (VQ) scheme (e.g., a GSVQ scheme). In another example, encoder IM10 is implemented to encode the entire frame of transform coefficients using a pulse coding scheme (e.g., factorial pulse coding or combinatorial pulse coding).

Apparatus A200 also includes an instance of apparatus A100 that is configured to encode target frame SM10, by performing a dynamic subband selection scheme as described herein that is based on information from a reference frame, to produce a dependent-mode encoded frame SD10. In one example, apparatus A200 includes an implementation of apparatus A100 that uses a VQ scheme (e.g., GSVQ) to encode the set of subbands and a pulse-coding method to encode the residual and that includes a storage element (e.g., memory) that is configured to store a decoded version of the previous encoded frame SE10 (e.g., as decoded by coding mode selector SEL10).

Apparatus A200 also includes a coding mode selector SEL10 that is configured to select one among independent-mode encoded frame SI10 and dependent-mode encoded frame SD10 according to an evaluation metric and to output the selected frame as encoded frame SE10. Encoded frame SE10 may include an indication of the selected coding mode, or such an indication may be transmitted separately from encoded frame SE10.

Selector SEL10 may be configured to select among the encoded frames by decoding them and comparing the decoded frames to the original target frame. In one example, selector SEL10 is implemented to select the frame having the lowest residual energy relative to the original target frame. In another example, selector SEL10 is implemented to select the frame according to a perceptual metric, such as a measure of signal-to-noise ratio (SNR) or other distortion measure.

It may be desirable to configure apparatus A100 (e.g., apparatus A130, A140, or A150) to perform a masking and/or LPC-weighting operation on the residual signal upstream and/or downstream of residual encoder 500 or 550. In one such example, the LPC coefficients corresponding to the LPC residual being encoded are used to modulate the residual signal upstream of the residual encoder. Such an operation is also called “pre-weighting,” and this modulation operation in the MDCT domain is similar to an LPC synthesis operation in the time domain. After the residual is decoded, the modulation is reversed (also called “post-weighting”). Together, the pre-weighting and post-weighting operations function as a mask. In such a case, coding mode selector SEL10 may be configured to use a weighted SNR measure to select among frames SI10 and SD10, such that the SNR operation is weighted by the same LPC synthesis filter used in the pre-weighting operation described above.

Coding mode selection (e.g., as described herein with reference to apparatus A200) may be extended to a multi-band case. In one such example, each of the lowband and the highband is encoded using both an independent coding mode (e.g., a fixed-division GSVQ mode and/or a pulse-coding mode) and a dependent coding mode (e.g., an implementation of method MC100), such that four different mode combinations are initially under consideration for the frame. Next, for each of the lowband modes, the best corresponding highband mode is selected (e.g., according to a comparison between the two options using a perceptual metric on the highband). Of the two remaining options (i.e., lowband independent mode with the corresponding best highband mode, and lowband dependent mode with the corresponding best highband mode), selection between these options is made with reference to a perceptual metric that covers both the lowband and the highband. In one example of such a multi-band case, the lowband independent mode groups the samples of the frame into subbands according to a predetermined (i.e., fixed) division scheme and encodes the subbands using a GSVQ scheme (e.g., as described herein with reference to encoder IM10), and the highband independent mode uses a pulse coding scheme (e.g., factorial pulse coding) to encode the highband signal.

It may be desirable to configure an audio codec to code different frequency bands of the same signal separately. For example, it may be desirable to configure such a codec to produce a first encoded signal that encodes a lowband portion of an audio signal and a second encoded signal that encodes a highband portion of the same audio signal. Applications in which such split-band coding may be desirable include wideband encoding systems that must remain compatible with narrowband decoding systems. Such applications also include generalized audio coding schemes that achieve efficient coding of a range of different types of audio input signals (e.g., both speech and music) by supporting the use of different coding schemes for different frequency bands.

For a case in which different frequency bands of a signal are encoded separately, it may be possible in some cases to increase coding efficiency in one band by using encoded (e.g., quantized) information from another band, as this encoded information will already be known at the decoder. For example, a relaxed harmonic model may be applied to use information from a decoded representation of the transform coefficients of a first band of an audio signal frame (also called the “source” band) to encode the transform coefficients of a second band of the same audio signal frame (also called the band “to be modeled”). For such a case in which the harmonic model is relevant, coding efficiency may be increased because the decoded representation of the first band is already available at the decoder.

Such an extended method may include determining subbands of the second band that are harmonically related to the coded first band. In low-bit-rate coding algorithms for audio signals (for example, complex music signals), it may be desirable to split a frame of the signal into multiple bands (e.g., a lowband and a highband) and to exploit a correlation between these bands to efficiently code the transform domain representation of the bands.

In a particular example of such extension, the MDCT coefficients corresponding to the 3.5-7 kHz band of an audio signal frame (henceforth referred to as upperband MDCT or UB-MDCT) are encoded based on the quantized lowband MDCT spectrum (0-4 kHz) of the frame, where the quantized lowband MDCT spectrum was encoded using an implementation of method MC100 as described herein. It is explicitly noted that in other examples of such extension, the two frequency ranges need not overlap and may even be separated (e.g., coding a 7-14 kHz band of a frame based on information from a decoded representation of the 0-4 kHz band as encoded using an implementation of method MC100 as described herein). Since the dependent-mode coded lowband MDCTs are used as a reference for coding the UB-MDCTs, many parameters of the highband coding model can be derived at the decoder without explicitly requiring their transmission. Additional description of harmonic modeling may be found in the applications listed above to which this application claims priority.

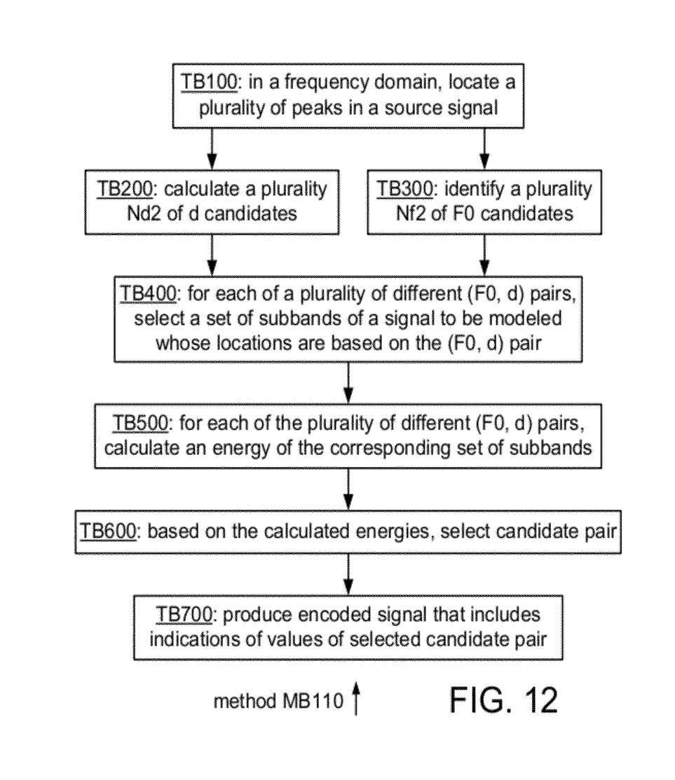

FIG. 12 shows a flowchart for a method MB110 of audio signal processing according to a general configuration that includes tasks TB100, TB200, TB300, TB400, TB500, TB600, and TB700. Task TB100 locates a plurality of peaks in a source audio signal (e.g., a dequantized representation of a first frequency range of an audio-frequency signal that was encoded using an implementation of method MC100 as described herein). Such an operation may also be referred to as “peak-picking.” Task TB100 may be configured to select a particular number of the highest peaks from the entire frequency range of the signal. Alternatively, task TB100 may be configured to select peaks from a specified frequency range of the signal (e.g., a low frequency range) or may be configured to apply different selection criteria in different frequency ranges of the signal. In a particular example as described herein, task TB100 is configured to locate at least a first number (Nd2+1) of the highest peaks in the frame, including at least a second number Nf2 of the highest peaks in a low-frequency range of the frame.

Task TB100 may be configured to identify a peak as a sample of the frequency-domain signal (also called a “bin”) that has the maximum value within some minimum distance to either side of the sample. In one such example, task TB100 is configured to identify a peak as the sample having the maximum value within a window of size (2dₘᵢₙ₂+1) that is centered at the sample, where dₘᵢₙ₂ is a minimum allowed spacing between peaks. The value of dₘᵢₙ₂ may be selected according to a maximum desired number of regions of significant energy (also called “subbands”) to be located. Examples of dₘᵢₙ₂ include eight, nine, ten, twelve, and fifteen samples (alternatively, 100, 125, 150, 175, 200, or 250 Hz), although any value suitable for the desired application may be used.

Based on the frequency-domain locations of at least some of the peaks located by task TB100, task TB200 calculates a plurality Nd2 of harmonic spacing candidates in the source audio signal. Examples of values for Nd2 include three, four, and five. Task TB200 may be configured to compute these spacing candidates as the distances (e.g., in terms of number of frequency bins) between adjacent ones of the (Nd2+1) largest peaks located by task TB100.

Based on the frequency-domain locations of at least some of the peaks located by task TB100, task TB300 identifies a plurality Nf2 of F0 candidates in the source audio signal. Examples of values for Nf2 include three, four, and five. Task TB300 may be configured to identify these candidates as the locations of the Nf2 highest peaks in the source audio signal. Alternatively, task TB300 may be configured to identify these candidates as the locations of the Nf2 highest peaks in a low-frequency portion (e.g., the lower 30, 35, 40, 45, or 50 percent) of the source frequency range. In one such example, task TB300 identifies the plurality Nf2of F0 candidates from among the locations of peaks located by task TB100 in the range of from 0 to 1250 Hz. In another such example, task TB300 identifies the plurality Nf2 of F0 candidates from among the locations of peaks located by task TB100 in the range of from 0 to 1600 Hz.

For each of a plurality of active pairs of the F0 and d candidates, task TB400 selects a set of subbands of a audio signal to be modeled (e.g., a representation of a second frequency range of the audio-frequency signal) whose locations in the frequency domain are based on the (F0, d) pair. The subbands are placed relative to the locations F0m, F0m+d, F0m+2d, etc., where the value of F0m is calculated by mapping F0 into the frequency range of the audio signal being modeled. Such a mapping may be performed according to an expression such as F0m=F0+Ld, where L is the smallest integer such that F0m is within the frequency range of the audio signal being modeled. In such case, the decoder may calculate the same value of L without further information from the encoder, as the frequency range of the audio signal to be modeled and the values of F0 and d are already known at the decoder.

In one example, task TB400 is configured to select the subbands of each set such that the first subband is centered at the corresponding F0m location, with the center of each subsequent subband being separated from the center of the previous subband by a distance equal to the corresponding value of d.

All of the different pairs of values of F0 and d may be considered to be active, such that task TB400 is configured to select a corresponding set of subbands for every possible (F0, d) pair. For a case in which Nf2 and Nd2 are both equal to four, for example, task TB400 may be configured to consider each of the sixteen possible pairs. Alternatively, task TB400 may be configured to impose a criterion for activity that some of the possible (F0, d) pairs may fail to meet. In such case, for example, task TB400 may be configured to ignore pairs that would produce more than a maximum allowable number of subbands (e.g., combinations of low values of F0 and d) and/or pairs that would produce less than a minimum desired number of subbands (e.g., combinations of high values of F0 and d).

For each of the plurality of active pairs of the F0 and d candidates, task TB500 calculates an energy of the corresponding set of subbands of the audio signal being modeled. In one such example, task TB500 calculates the total energy of a set of subbands as a sum of the squared magnitudes of the frequency-domain sample values in the subbands. Task TB500 may also be configured to calculate an energy for each individual subband and/or to calculate an average energy per subband (e.g., total energy normalized over the number of subbands) for each of the sets of subbands.

Although FIG. 12 shows execution of tasks TB400 and TB500 in series, it will be understood that task TB500 may also be implemented to begin to calculate energies for sets of subbands before task TB400 has completed. For example, task TB500 may be implemented to begin to calculate (or even to finish calculating) the energy for a set of subbands before task TB400 begins to select the next set of subbands. In one such example, tasks TB400 and TB500 are configured to alternate for each of the plurality of active pairs of the FO and d candidates. Likewise, task TB400 may also be implemented to begin execution before task TB200 and TB300 have completed.

Based on the calculated energies of the sets of subbands, task TB600 selects a candidate pair from among the (F0, d) candidate pairs. In one example, task TB600 selects the pair corresponding to the set of subbands having the highest total energy. In another example, task TB600 selects the candidate pair corresponding to the set of subbands having the highest average energy per subband. In a further example, task TB600 is implemented to sort the plurality of active candidate pairs according to the average energy per subband of the corresponding sets of subbands (e.g., in descending order), and then to select, from among the Pv candidate pairs that produce the subband sets having the highest average energies per subband, the candidate pair associated with the subband set that captures the most total energy. It may be desirable to use a fixed value for Pv (e.g., four, five, six, seven, eight, nine, or ten) or, alternatively, to use a value of Pv that is related to the total number of active candidate pairs (e.g., equal to or not more than ten, twenty, or twenty-five percent of the total number of active candidate pairs).

Task TB700 produces an encoded signal that includes indications of the values of the selected candidate pair. Task TB700 may be configured to encode the selected value of F0, or to encode an offset of the selected value of F0 from a minimum (or maximum) location. Similarly, task TB700 may be configured to encode the selected value of d, or to encode an offset of the selected value of d from a minimum or maximum distance. In a particular example, task TB700 uses six bits to encode the selected F0 value and six bits to encode the selected d value. In further examples, task TB700 may be implemented to encode the current value of F0 and/or d differentially (e.g., as an offset relative to a previous value of the parameter).

It may be desirable to implement task TB700 to use a VQ coding scheme (e.g., GSVQ) to encode the selected set of subbands as vectors. It may be desirable to use a GSVQ scheme that includes predictive gain coding such that the gain factors for each set of subbands are encoded independently from one another and differentially with respect to the corresponding gain factor of the previous frame. In a particular example, method MB110 is arranged to encode regions of significant energy in a frequency range of an UB-MDCT spectrum.

Because the source audio signal is available at the decoder, tasks TB100, TB200, and TB300 may also be performed at the decoder to obtain the same plurality (or “codebook”) Nf2 of F0 candidates and the same plurality (“codebook”) Nd2 of d candidates from the same source audio signal. The values in each codebook may be sorted, for example, in order of increasing value. Consequently, it is sufficient for the encoder to transmit an index into each of these ordered pluralities, instead of encoding the actual values of the selected (F0, d) pair. For a particular example in which Nf2 and Nd2 are both equal to four, task TB700 may be implemented to use a two-bit codebook index to indicate the selected d value and another two-bit codebook index to indicate the selected F0 value.

A method of decoding an encoded modeled audio signal produced by task TB700 may also include selecting the values of F0 and d indicated by the indices, dequantizing the selected set of subbands, calculating the mapping value m, and constructing a decoded modeled audio signal by placing (e.g., centering) each subband p at the frequency-domain location F0m+pd, where 0<=p<P and P is the number of subbands in the selected set. Unoccupied bins of the decoded modeled signal may be assigned zero values or, alternatively, values of a decoded residual as described herein.

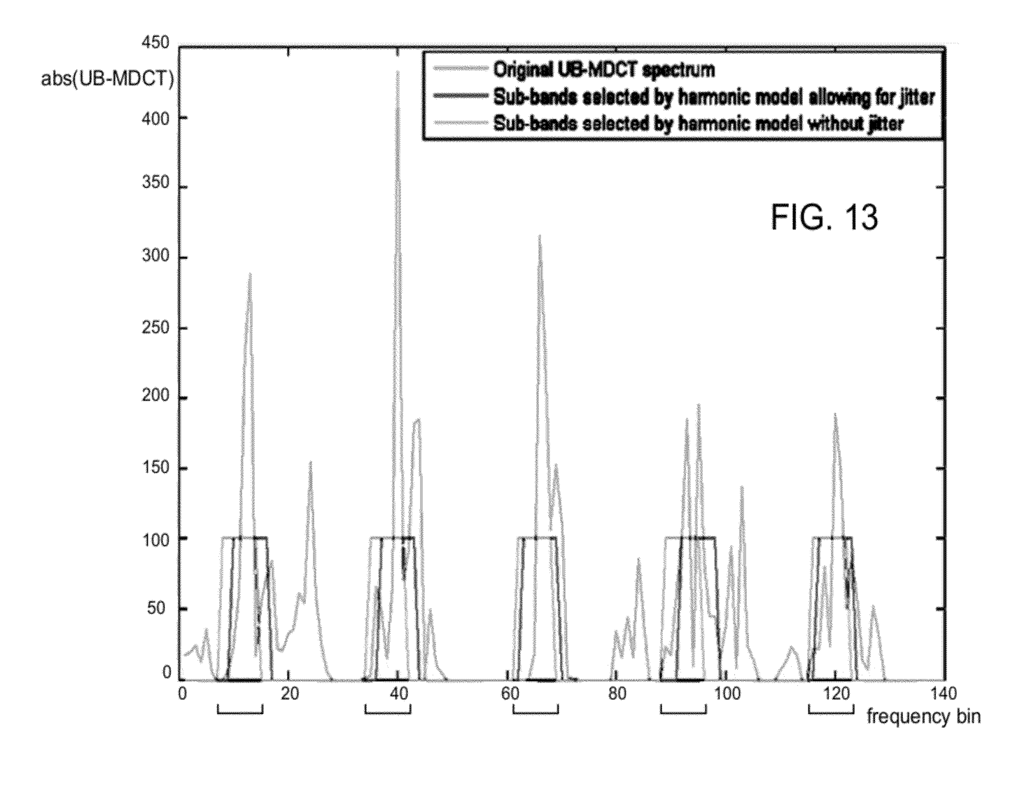

FIG. 13 shows a plot of magnitude vs. frequency for an example in which the audio signal being modeled is a UB-MDCT signal of 140 transform coefficients that represent the audio-frequency spectrum of 3.5-7 kHz. This figure shows the audio signal being modeled (gray line), a set of five uniformly spaced subbands selected according to an (F0, d) candidate pair (indicated by the blocks drawn in gray and by the brackets), and a set of five jittered subbands selected according to the (F0, d) pair and a peak-centering criterion (indicated by the blocks drawn in black). As shown in this example, the UB-MDCT spectrum may be calculated from a highband signal that has been converted to a lower sampling rate or otherwise shifted for coding purposes to begin at frequency bin zero or one. In such case, each mapping of F0m also includes a shift to indicate the appropriate frequency within the shifted spectrum. In a particular example, the first frequency bin of the UB-MDCT spectrum of the audio signal being modeled corresponds to bin 140 of the LB-MDCT spectrum of the source audio signal (e.g., representing acoustic content at 3.5 kHz), such that task TB400 may be implemented to map each F0 to a corresponding F0m according to an expression such as F0m=F0+Ld−140.

For each subband, it may be desirable to select the jitter value that centers the peak within the subband if possible or, if no such jitter value is available, the jitter value that partially centers the peak or, if no such jitter value is available, the jitter value that maximizes the energy captured by the subband.

In one example, task TB400 is configured to select the (F0, d) pair that compacts the maximum energy per subband in the signal being modeled (e.g., the UB-MDCT spectrum). Energy compaction may also be used as a measure to decide between two or more jitter candidates which center or partially center.

The jitter parameter values (e.g., one for each subband) may be transmitted to the decoder. If the jitter values are not transmitted to the decoder, then an error may arise in the frequency locations of the harmonic model subbands. For modeled signals that represent a highband audio-frequency range (e.g., the 3.5-7 kHz range), however, this error is typically not perceivable, such that it may be desirable to encode the subbands according to the selected jitter values but not to send those jitter values to the decoder, and the subbands may be uniformly spaced (e.g., based only on the selected (F0, d) pair) at the decoder. For very low bit-rate coding of music signals (e.g., about twenty kilobits per second), for example, it may be desirable not to transmit the jitter parameter values and to allow an error in the locations of the subbands at the decoder.

After the set of selected subbands has been identified, a residual signal may be calculated at the encoder by subtracting the reconstructed modeled signal from the original spectrum of the signal being modeled (e.g., as the difference between the original signal spectrum and the reconstructed harmonic-model subbands). Alternatively, the residual signal may be calculated as a concatenation of the regions of the spectrum of the signal being modeled that were not captured by the harmonic modeling (e.g., those bins that were not included in the selected subbands). For a case in which the audio signal being modeled is a UB-MDCT spectrum and the source audio signal is a reconstructed LB-MDCT spectrum, it may be desirable to obtain the residual by concatenating the uncaptured regions, especially for a case in which jitter values used to encode the audio signal being modeled will not be available at the decoder. The selected subbands may be coded using a vector quantization scheme (e.g., a GSVQ scheme), and the residual signal may be coded using a factorial pulse coding scheme or a combinatorial pulse coding scheme.

If the jitter parameter values are available at the decoder, then the residual signal may be put back into the same bins at the decoder as at the encoder. If the jitter parameter values are not available at the decoder (e.g., for low bit-rate coding of music signals), the selected subbands may be placed at the decoder according to a uniform spacing based on the selected (F0, d) pair as described above. In this case, the residual signal can be inserted between the selected subbands using one of several different methods as described above (e.g., zeroing out each jitter range in the residual before adding it to the jitterless reconstructed signal, using the residual to fill unoccupied bins while moving residual energy that would overlap a selected subband, or frequency-warping the residual).

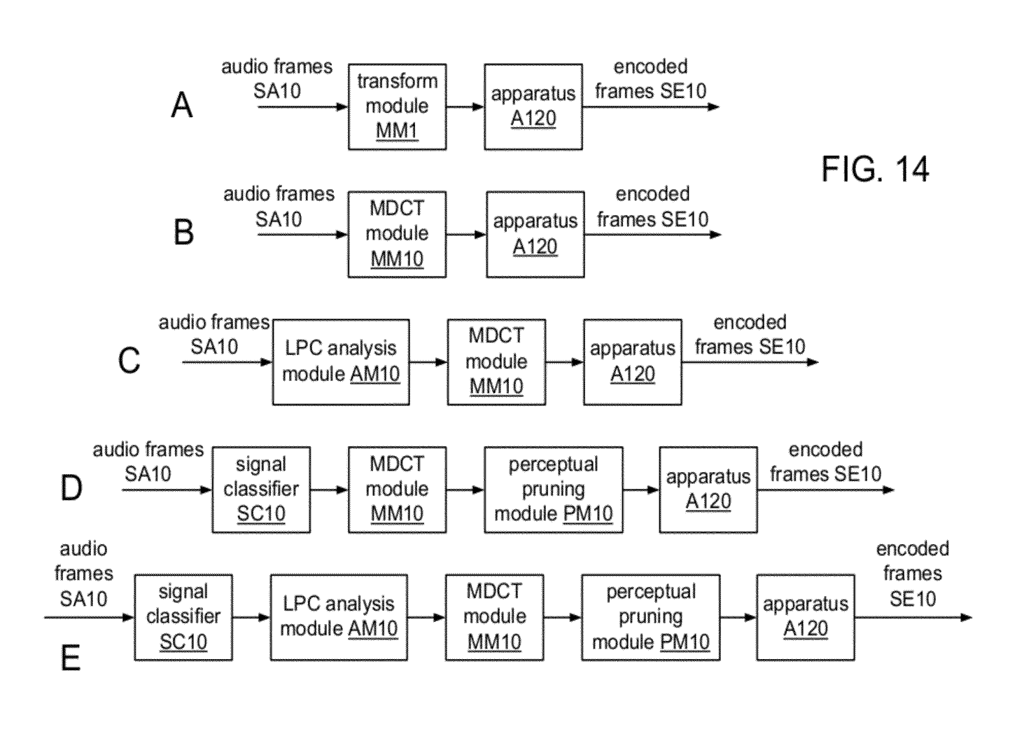

FIGS. 14A-E show a range of applications for the various implementations of apparatus A120 (e.g., A130, A140, A150, A200) as described herein. FIG. 14A shows a block diagram of an audio processing path that includes a transform module MM1 (e.g., a fast Fourier transform or MDCT module) and an instance of apparatus A120 that is arranged to receive the audio frames SA10 as samples in the transform domain (i.e., as transform domain coefficients) and to produce corresponding encoded frames SE10.

FIG. 14B shows a block diagram of an implementation of the path of FIG. 14A in which transform module MM1 is implemented using an MDCT transform module. Modified DCT module MM10 performs an MDCT operation on each audio frame to produce a set of MDCT domain coefficients.

FIG. 14C shows a block diagram of an implementation of the path of FIG. 14A that includes a linear prediction coding analysis module AM10. Linear prediction coding (LPC) analysis module AM10 performs an LPC analysis operation on the classified frame to produce a set of LPC parameters (e.g., filter coefficients) and an LPC residual signal. In one example, LPC analysis module AM10 is configured to perform a tenth-order LPC analysis on a frame having a bandwidth of from zero to 4000 Hz. In another example, LPC analysis module AM10 is configured to perform a sixth-order LPC analysis on a frame that represents a highband frequency range of from 3500 to 7000 Hz. Modified DCT module MM10 performs an MDCT operation on the LPC residual signal to produce a set of transform domain coefficients. A corresponding decoding path may be configured to decode encoded frames SE10 and to perform an inverse MDCT transform on the decoded frames to obtain an excitation signal for input to an LPC synthesis filter.

FIG. 14D shows a block diagram of a processing path that includes a signal classifier SC10. Signal classifier SC10 receives frames SA10 of an audio signal and classifies each frame into one of at least two categories. For example, signal classifier SC10 may be configured to classify a frame SA10 as speech or music, such that if the frame is classified as music, then the rest of the path shown in FIG. 14D is used to encode it, and if the frame is classified as speech, then a different processing path is used to encode it. Such classification may include signal activity detection, noise detection, periodicity detection, time-domain sparseness detection, and/or frequency-domain sparseness detection.

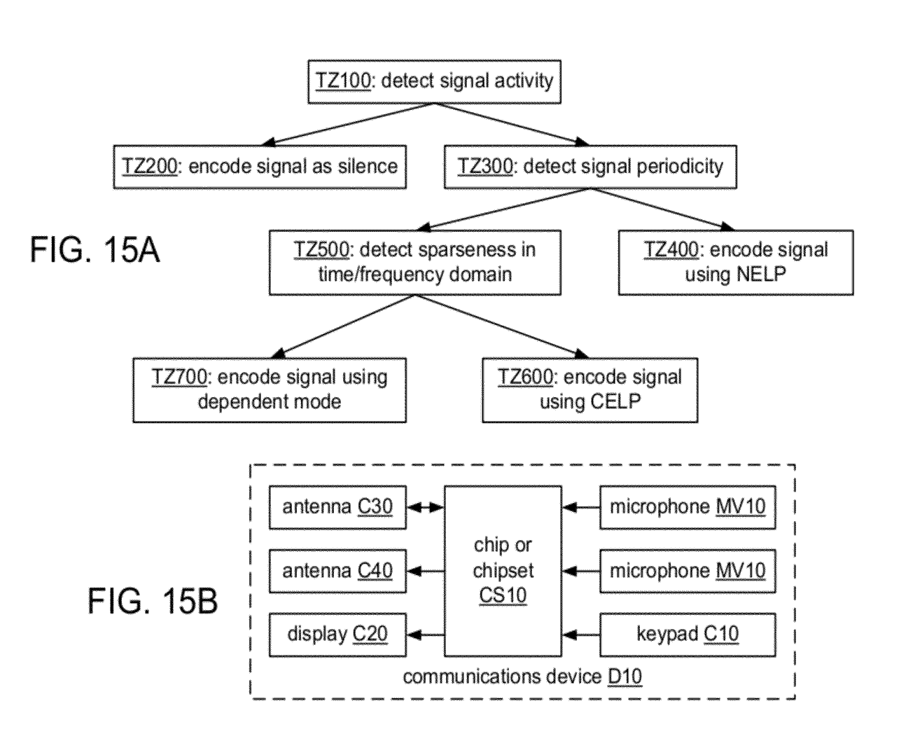

FIG. 15A shows a block diagram of a method MZ100 of signal classification that may be performed by signal classifier SC10 (e.g., on each of the audio frames SA10). Method MC100 includes tasks TZ100, TZ200, TZ300, TZ400, TZ500, and TZ600. Task TZ100 quantifies a level of activity in the signal. If the level of activity is below a threshold, task TZ200 encodes the signal as silence (e.g., using a low-bit-rate noise-excited linear prediction (NELP) scheme and/or a discontinuous transmission (DTX) scheme). If the level of activity is sufficiently high (e.g., above the threshold), task TZ300 quantifies a degree of periodicity of the signal. If task TZ300 determines that the signal is not periodic, task TZ400 encodes the signal using a NELP scheme. If task TZ300 determines that the signal is periodic, task TZ500 quantifies a degree of sparsity of the signal in the time and/or frequency domain. If task TZ500 determines that the signal is sparse in the time domain, task TZ600 encodes the signal using a code-excited linear prediction (CELP) scheme, such as relaxed CELP (RCELP) or algebraic CELP (ACELP). If task TZ500 determines that the signal is sparse in the frequency domain, task TZ700 encodes the signal using a harmonic model (e.g., by passing the signal to the rest of the processing path in FIG. 14D).

As shown in FIG. 14D, the processing path may include a perceptual pruning module PM10 that is configured to simplify the MDCT-domain signal (e.g., to reduce the number of transform domain coefficients to be encoded) by applying psychoacoustic criteria such as time masking, frequency masking, and/or hearing threshold. Module PM10 may be implemented to compute the values for such criteria by applying a perceptual model to the original audio frames SA10. In this example, apparatus A120 is arranged to encode the pruned frames to produce corresponding encoded frames SE10.

FIG. 14E shows a block diagram of an implementation of both of the paths of FIGS. 14C and 14D, in which apparatus A120 is arranged to encode the LPC residual.

FIG. 15B shows a block diagram of a communications device D10 that includes an implementation of apparatus A100. Device D10 includes a chip or chipset CS10 (e.g., a mobile station modem (MSM) chipset) that embodies the elements of apparatus A100 (or MF100) and possibly of A100D (or MFD100). Chip/chipset CS10 may include one or more processors, which may be configured to execute a software and/or firmware part of apparatus A100 or MF100 (e.g., as instructions).

Chip/chipset CS10 includes a receiver, which is configured to receive a radio-frequency (RF) communications signal and to decode and reproduce an audio signal encoded within the RF signal, and a transmitter, which is configured to transmit an RF communications signal that describes an encoded audio signal (e.g., as produced by task TC300 or bit packer 360). Such a device may be configured to transmit and receive voice communications data wirelessly via one or more encoding and decoding schemes (also called “codecs”). Examples of such codecs include the Enhanced Variable Rate Codec, as described in the Third Generation Partnership Project 2 (3GPP2) document C.S0014-C, v1.0, entitled “Enhanced Variable Rate Codec, Speech Service Options 3, 68, and 70 for Wideband Spread Spectrum Digital Systems,” February 2007 (available online at www-dot-3gpp-dot-org); the Selectable Mode Vocoder speech codec, as described in the 3GPP2 document C.S0030-0, v3.0, entitled “Selectable Mode Vocoder (SMV) Service Option for Wideband Spread Spectrum Communication Systems,” January 2004 (available online at www-dot-3gpp-dot-org); the Adaptive Multi Rate (AMR) speech codec, as described in the document ETSI TS 126 092 V6.0.0 (European Telecommunications Standards Institute (ETSI), Sophia Antipolis Cedex, FR, December 2004); and the AMR Wideband speech codec, as described in the document ETSI TS 126 192 V6.0.0 (ETSI, December 2004). For example, bit packer 360 may be configured to produce the encoded frames to be compliant with one or more such codecs.

Device D10 is configured to receive and transmit the RF communications signals via an antenna C30. Device D10 may also include a diplexer and one or more power amplifiers in the path to antenna C30. Chip/chipset CS10 is also configured to receive user input via keypad C10 and to display information via display C20. In this example, device D10 also includes one or more antennas C40 to support Global Positioning System (GPS) location services and/or short-range communications with an external device such as a wireless (e.g., Bluetooth™) headset. In another example, such a communications device is itself a Bluetooth™ headset and lacks keypad C10, display C20, and antenna C30.

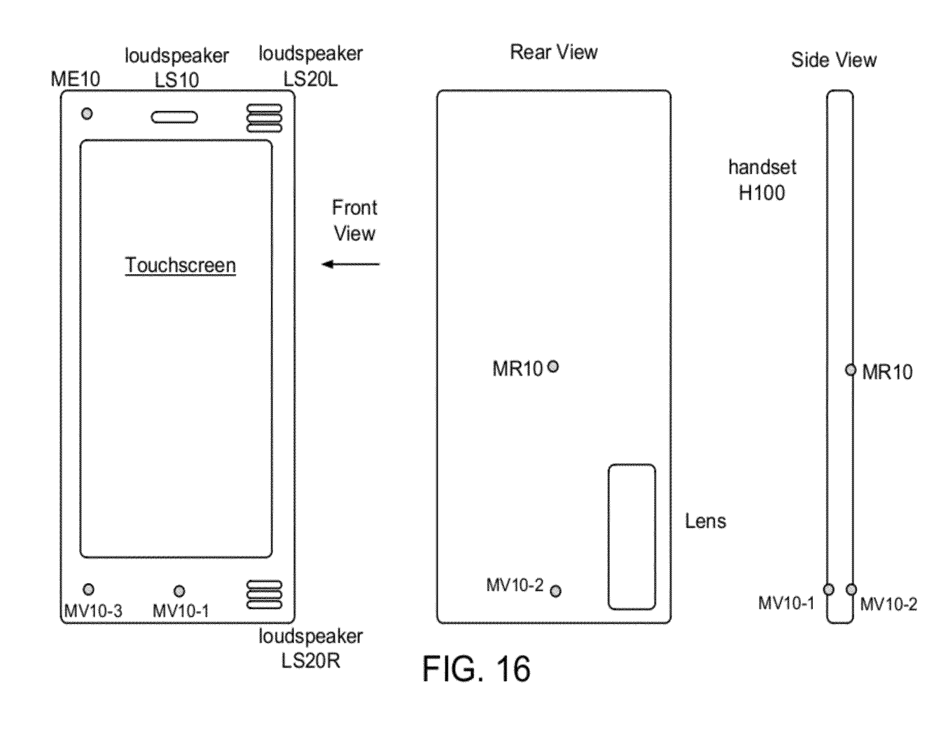

Communications device D10 may be embodied in a variety of communications devices, including smartphones and laptop and tablet computers. FIG. 16 shows front, rear, and side views of a handset H100 (e.g., a smartphone) having two voice microphones MV10-1 and MV10-3 arranged on the front face, a voice microphone MV10-2 arranged on the rear face, an error microphone ME10 located in a top corner of the front face, and a noise reference microphone MR10 located on the back face. A loudspeaker LS10 is arranged in the top center of the front face near error microphone ME10, and two other loudspeakers LS20L, LS20R are also provided (e.g., for speakerphone applications). A maximum distance between the microphones of such a handset is typically about ten or twelve centimeters.

The methods and apparatus disclosed herein may be applied generally in any transceiving and/or audio sensing application, especially mobile or otherwise portable instances of such applications. For example, the range of configurations disclosed herein includes communications devices that reside in a wireless telephony communication system configured to employ a code-division multiple-access (CDMA) over-the-air interface. Nevertheless, it would be understood by those skilled in the art that a method and apparatus having features as described herein may reside in any of the various communication systems employing a wide range of technologies known to those of skill in the art, such as systems employing Voice over IP (VoIP) over wired and/or wireless (e.g., CDMA, TDMA, FDMA, and/or TD-SCDMA) transmission channels.

It is expressly contemplated and hereby disclosed that communications devices disclosed herein may be adapted for use in networks that are packet-switched (for example, wired and/or wireless networks arranged to carry audio transmissions according to protocols such as VoIP) and/or circuit-switched. It is also expressly contemplated and hereby disclosed that communications devices disclosed herein may be adapted for use in narrowband coding systems (e.g., systems that encode an audio frequency range of about four or five kilohertz) and/or for use in wideband coding systems (e.g., systems that encode audio frequencies greater than five kilohertz), including whole-band wideband coding systems and split-band wideband coding systems.

The presentation of the described configurations is provided to enable any person skilled in the art to make or use the methods and other structures disclosed herein. The flowcharts, block diagrams, and other structures shown and described herein are examples only, and other variants of these structures are also within the scope of the disclosure. Various modifications to these configurations are possible, and the generic principles presented herein may be applied to other configurations as well. Thus, the present disclosure is not intended to be limited to the configurations shown above but rather is to be accorded the widest scope consistent with the principles and novel features disclosed in any fashion herein, including in the attached claims as filed, which form a part of the original disclosure.

Those of skill in the art will understand that information and signals may be represented using any of a variety of different technologies and techniques. For example, data, instructions, commands, information, signals, bits, and symbols that may be referenced throughout the above description may be represented by voltages, currents, electromagnetic waves, magnetic fields or particles, optical fields or particles, or any combination thereof.

Important design requirements for implementation of a configuration as disclosed herein may include minimizing processing delay and/or computational complexity (typically measured in millions of instructions per second or MIPS), especially for computation-intensive applications, such as playback of compressed audio or audiovisual information (e.g., a file or stream encoded according to a compression format, such as one of the examples identified herein) or applications for wideband communications (e.g., voice communications at sampling rates higher than eight kilohertz, such as 12, 16, 44.1, 48, or 192 kHz).

An apparatus as disclosed herein (e.g., apparatus A100, A110, A120, A130, A140, A150, A200, A100D, A110D, A120D, MF100, MF110, MFD100, or MFD110) may be implemented in any combination of hardware with software, and/or with firmware, that is deemed suitable for the intended application. For example, such elements may be fabricated as electronic and/or optical devices residing, for example, on the same chip or among two or more chips in a chipset. One example of such a device is a fixed or programmable array of logic elements, such as transistors or logic gates, and any of these elements may be implemented as one or more such arrays. Any two or more, or even all, of these elements may be implemented within the same array or arrays. Such an array or arrays may be implemented within one or more chips (for example, within a chipset including two or more chips).

One or more elements of the various implementations of the apparatus disclosed herein (e.g., apparatus A100, A110, A120, A130, A140, A150, A200, A100D, A110D, A120D, MF100, MF110, MFD100, or MFD110) may be implemented in whole or in part as one or more sets of instructions arranged to execute on one or more fixed or programmable arrays of logic elements, such as microprocessors, embedded processors, IP cores, digital signal processors, FPGAs (field-programmable gate arrays), ASSPs (application-specific standard products), and ASICs (application-specific integrated circuits). Any of the various elements of an implementation of an apparatus as disclosed herein may also be embodied as one or more computers (e.g., machines including one or more arrays programmed to execute one or more sets or sequences of instructions, also called “processors”), and any two or more, or even all, of these elements may be implemented within the same such computer or computers.

A processor or other means for processing as disclosed herein may be fabricated as one or more electronic and/or optical devices residing, for example, on the same chip or among two or more chips in a chipset. One example of such a device is a fixed or programmable array of logic elements, such as transistors or logic gates, and any of these elements may be implemented as one or more such arrays. Such an array or arrays may be implemented within one or more chips (for example, within a chipset including two or more chips). Examples of such arrays include fixed or programmable arrays of logic elements, such as microprocessors, embedded processors, IP cores, DSPs, FPGAs, ASSPs, and ASICs. A processor or other means for processing as disclosed herein may also be embodied as one or more computers (e.g., machines including one or more arrays programmed to execute one or more sets or sequences of instructions) or other processors. It is possible for a processor as described herein to be used to perform tasks or execute other sets of instructions that are not directly related to a procedure of an implementation of method MC100, MC110, MD100, or MD110, such as a task relating to another operation of a device or system in which the processor is embedded (e.g., an audio sensing device). It is also possible for part of a method as disclosed herein to be performed by a processor of the audio sensing device and for another part of the method to be performed under the control of one or more other processors.

Those of skill will appreciate that the various illustrative modules, logical blocks, circuits, and tests and other operations described in connection with the configurations disclosed herein may be implemented as electronic hardware, computer software, or combinations of both. Such modules, logical blocks, circuits, and operations may be implemented or performed with a general purpose processor, a digital signal processor (DSP), an ASIC or ASSP, an FPGA or other programmable logic device, discrete gate or transistor logic, discrete hardware components, or any combination thereof designed to produce the configuration as disclosed herein. For example, such a configuration may be implemented at least in part as a hard-wired circuit, as a circuit configuration fabricated into an application-specific integrated circuit, or as a firmware program loaded into non-volatile storage or a software program loaded from or into a data storage medium as machine-readable code, such code being instructions executable by an array of logic elements such as a general purpose processor or other digital signal processing unit. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. A software module may reside in a non-transitory storage medium such as RAM (random-access memory), ROM (read-only memory), nonvolatile RAM (NVRAM) such as flash RAM, erasable programmable ROM (EPROM), electrically erasable programmable ROM (EEPROM), registers, hard disk, a removable disk, or a CD-ROM; or in any other form of storage medium known in the art. An illustrative storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

It is noted that the various methods disclosed herein (e.g., methods MC100, MC110, MD100, MD110, and other methods disclosed with reference to the operation of the various apparatus described herein) may be performed by an array of logic elements such as a processor, and that the various elements of an apparatus as described herein may be implemented as modules designed to execute on such an array. As used herein, the term “module” or “sub-module” can refer to any method, apparatus, device, unit or computer-readable data storage medium that includes computer instructions (e.g., logical expressions) in software, hardware or firmware form. It is to be understood that multiple modules or systems can be combined into one module or system and one module or system can be separated into multiple modules or systems to perform the same functions. When implemented in software or other computer-executable instructions, the elements of a process are essentially the code segments to perform the related tasks, such as with routines, programs, objects, components, data structures, and the like. The term “software” should be understood to include source code, assembly language code, machine code, binary code, firmware, macrocode, microcode, any one or more sets or sequences of instructions executable by an array of logic elements, and any combination of such examples. The program or code segments can be stored in a processor readable medium or transmitted by a computer data signal embodied in a carrier wave over a transmission medium or communication link.

The implementations of methods, schemes, and techniques disclosed herein may also be tangibly embodied (for example, in tangible, computer-readable features of one or more computer-readable storage media as listed herein) as one or more sets of instructions executable by a machine including an array of logic elements (e.g., a processor, microprocessor, microcontroller, or other finite state machine). The term “computer-readable medium” may include any medium that can store or transfer information, including volatile, nonvolatile, removable, and non-removable storage media. Examples of a computer-readable medium include an electronic circuit, a semiconductor memory device, a ROM, a flash memory, an erasable ROM (EROM), a floppy diskette or other magnetic storage, a CD-ROM/DVD or other optical storage, a hard disk or any other medium which can be used to store the desired information, a fiber optic medium, a radio frequency (RF) link, or any other medium which can be used to carry the desired information and can be accessed. The computer data signal may include any signal that can propagate over a transmission medium such as electronic network channels, optical fibers, air, electromagnetic, RF links, etc. The code segments may be downloaded via computer networks such as the Internet or an intranet. In any case, the scope of the present disclosure should not be construed as limited by such embodiments.

Each of the tasks of the methods described herein may be embodied directly in hardware, in a software module executed by a processor, or in a combination of the two. In a typical application of an implementation of a method as disclosed herein, an array of logic elements (e.g., logic gates) is configured to perform one, more than one, or even all of the various tasks of the method. One or more (possibly all) of the tasks may also be implemented as code (e.g., one or more sets of instructions), embodied in a computer program product (e.g., one or more data storage media such as disks, flash or other nonvolatile memory cards, semiconductor memory chips, etc.), that is readable and/or executable by a machine (e.g., a computer) including an array of logic elements (e.g., a processor, microprocessor, microcontroller, or other finite state machine). The tasks of an implementation of a method as disclosed herein may also be performed by more than one such array or machine. In these or other implementations, the tasks may be performed within a device for wireless communications such as a cellular telephone or other device having such communications capability. Such a device may be configured to communicate with circuit-switched and/or packet-switched networks (e.g., using one or more protocols such as VoIP). For example, such a device may include RF circuitry configured to receive and/or transmit encoded frames.

It is expressly disclosed that the various methods disclosed herein may be performed by a portable communications device such as a handset, headset, or portable digital assistant (PDA), and that the various apparatus described herein may be included within such a device. A typical real-time (e.g., online) application is a telephone conversation conducted using such a mobile device.

In one or more exemplary embodiments, the operations described herein may be implemented in hardware, software, firmware, or any combination thereof. If implemented in software, such operations may be stored on or transmitted over a computer-readable medium as one or more instructions or code. The term “computer-readable media” includes both computer-readable storage media and communication (e.g., transmission) media. By way of example, and not limitation, computer-readable storage media can comprise an array of storage elements, such as semiconductor memory (which may include without limitation dynamic or static RAM, ROM, EEPROM, and/or flash RAM), or ferroelectric, magnetoresistive, ovonic, polymeric, or phase-change memory; CD-ROM or other optical disk storage; and/or magnetic disk storage or other magnetic storage devices. Such storage media may store information in the form of instructions or data structures that can be accessed by a computer. Communication media can comprise any medium that can be used to carry desired program code in the form of instructions or data structures and that can be accessed by a computer, including any medium that facilitates transfer of a computer program from one place to another. Also, any connection is properly termed a computer-readable medium. For example, if the software is transmitted from a website, server, or other remote source using a coaxial cable, fiber optic cable, twisted pair, digital subscriber line (DSL), or wireless technology such as infrared, radio, and/or microwave, then the coaxial cable, fiber optic cable, twisted pair, DSL, or wireless technology such as infrared, radio, and/or microwave are included in the definition of medium. Disk and disc, as used herein, includes compact disc (CD), laser disc, optical disc, digital versatile disc (DVD), floppy disk and Blu-ray Disc™ (Blu-Ray Disc Association, Universal City, Calif.), where disks usually reproduce data magnetically, while discs reproduce data optically with lasers. Combinations of the above should also be included within the scope of computer-readable media.

An acoustic signal processing apparatus as described herein may be incorporated into an electronic device that accepts speech input in order to control certain operations, or may otherwise benefit from separation of desired noises from background noises, such as communications devices. Many applications may benefit from enhancing or separating clear desired sound from background sounds originating from multiple directions. Such applications may include human-machine interfaces in electronic or computing devices which incorporate capabilities such as voice recognition and detection, speech enhancement and separation, voice-activated control, and the like. It may be desirable to implement such an acoustic signal processing apparatus to be suitable in devices that only provide limited processing capabilities.

The elements of the various implementations of the modules, elements, and devices described herein may be fabricated as electronic and/or optical devices residing, for example, on the same chip or among two or more chips in a chipset. One example of such a device is a fixed or programmable array of logic elements, such as transistors or gates. One or more elements of the various implementations of the apparatus described herein may also be implemented in whole or in part as one or more sets of instructions arranged to execute on one or more fixed or programmable arrays of logic elements such as microprocessors, embedded processors, IP cores, digital signal processors, FPGAs, ASSPs, and ASICs.

It is possible for one or more elements of an implementation of an apparatus as described herein to be used to perform tasks or execute other sets of instructions that are not directly related to an operation of the apparatus, such as a task relating to another operation of a device or system in which the apparatus is embedded. It is also possible for one or more elements of an implementation of such an apparatus to have structure in common (e.g., a processor used to execute portions of code corresponding to different elements at different times, a set of instructions executed to perform tasks corresponding to different elements at different times, or an arrangement of electronic and/or optical devices performing operations for different elements at different times).

1. A method of audio signal processing, said method comprising performing each of the following acts in a device that is configured to process frames of an audio signal:
in a frequency domain, locating a plurality of concentrations of energy in a reference frame that describes a frame of the audio signal;
for each of the plurality of frequency-domain concentrations of energy, and based on a location of the concentration, selecting a location within a target frame of the audio signal for a corresponding one of a set of subbands of the target frame, wherein the target frame is subsequent in the audio signal to the frame that is described by the reference frame; and
encoding the set of subbands of the target frame separately from samples of the target frame that are not in any of the set of subbands to obtain an encoded component,
wherein the encoded component includes, for each of at least one of the set of subbands, an indication of a distance in the frequency domain between the selected location for the subband and the location of the corresponding concentration.

2. The method according to claim 1, wherein each among the plurality of concentrations of energy in the reference frame is a peak.

3. The method according to claim 1, wherein said selecting the location comprises selecting one among a plurality of candidates that includes the location of the concentration.

4. The method according to claim 1, wherein the samples of the target frame that are not in any of the set of subbands include samples that are located between adjacent ones of the set of subbands.

5. The method according to claim 1, wherein said method comprises dequantizing an encoded signal to obtain the reference frame.

6. The method according to claim 1, wherein said encoding includes performing a gain-shape vector quantization operation on at least one among the set of subbands.

7. The method according to claim 1, wherein the audio signal is based on a linear prediction coding residual.

8. The method according to claim 1, wherein the target frame is a plurality of modified discrete cosine transform coefficients.

9. The method according to claim 1, wherein the encoded component includes, for each of the set of subbands, an indication of a distance in the frequency domain between the selected location for the subband and the location of the corresponding concentration.

10. The method according to claim 1, wherein, for at least one of the set of subbands, said selecting the location for the subband includes selecting a corresponding jitter value.

11. The method according to claim 1, wherein said method comprises producing an encoded frame that includes (A) the encoded component and (B) a representation of an ordered series of values of samples of the target frame that are not in any of the set of subbands.

12. The method according to claim 1, wherein said method comprises:
decoding the encoded component to obtain a decoded set of subbands;
subtracting the decoded set of subbands from the target frame to obtain a residual;
encoding the residual to obtain an encoded residual; and
producing an encoded frame that includes (A) the encoded component and (B) the encoded residual.

13. The method according to claim 1, wherein said method comprises:
encoding the target frame by grouping the samples of the frame into a second set of subbands according to a predetermined division scheme to obtain a second encoded frame; and
using a perceptual metric to select one among the encoded frame and the second encoded frame.

14. A method of constructing a decoded audio frame, said method comprising:
in a frequency domain, locating a plurality of concentrations of energy in a reference frame that describes a frame of the audio signal;
decoding information from an encoded target frame to obtain a decoded contents and a jitter value for each of a plurality of subbands; and
placing the decoded contents of each subband according to the corresponding jitter value and a corresponding one of the plurality of locations to obtain a decoded target frame.

15. The method according to claim 14, wherein said method comprises dequantizing an encoded signal to obtain the reference frame.

16. An apparatus for processing frames of an audio signal, said apparatus comprising:
means for locating, in a frequency domain, a plurality of concentrations of energy in a reference frame that describes a frame of the audio signal;
means for selecting, for each of the first plurality of frequency-domain concentrations of energy and based on a location of the concentration, a location within a target frame of the audio signal for a corresponding one of a set of subbands of the target frame, wherein the target frame is subsequent in the audio signal to the frame that is described by the reference frame; and
means for encoding the set of subbands of the target frame separately from samples of the target frame that are not in any of the set of subbands to obtain an encoded component,
wherein the encoded component includes, for each of at least one of the set of subbands, an indication of a distance in the frequency domain between the selected location for the subband and the location of the corresponding concentration.

17. The apparatus according to claim 16, wherein each among the plurality of concentrations of energy in the reference frame is a peak.

18. The apparatus according to claim 16, wherein said means for selecting the location comprises means for selecting one among a plurality of candidates that includes the location of the concentration.

19. The apparatus according to claim 16, wherein the samples of the target frame that are not in any of the set of subbands include samples that are located between adjacent ones of the set of subbands.

20. The apparatus according to claim 16, wherein said apparatus comprises means for dequantizing an encoded signal to obtain the reference frame.

21. The apparatus according to claim 16, wherein said means for encoding includes means for performing a gain-shape vector quantization operation on at least one among the set of subbands.

22. The apparatus according to claim 16, wherein the audio signal is based on a linear prediction coding residual.

23. The apparatus according to claim 16, wherein the target frame is a plurality of modified discrete cosine transform coefficients.

24. The apparatus according to claim 16, wherein the encoded component includes, for each of the set of subbands, an indication of a distance in the frequency domain between the selected location for the subband and the location of the corresponding concentration.

25. The apparatus according to claim 16, wherein said selected location includes, for at least one of the set of subbands, a corresponding jitter value.

26. The apparatus according to claim 16, wherein said apparatus comprises means for producing an encoded frame that includes (A) the encoded component and (B) a representation of an ordered series of values of samples of the target frame that are not in any of the set of subbands.

27. The apparatus according to claim 16, wherein said apparatus comprises:
means for decoding the encoded component to obtain a decoded set of subbands;
means for subtracting the decoded set of subbands from the target frame to obtain a residual;
means for encoding the residual to obtain an encoded residual; and
means for producing an encoded frame that includes (A) the encoded component and (B) the encoded residual.

28. An apparatus for processing frames of an audio signal, said apparatus comprising:
a locator configured to locate, in a frequency domain, a plurality of concentrations of energy in a reference frame that describes a frame of the audio signal;
a selector configured to select, for each of the first plurality of frequency-domain concentrations of energy and based on a location of the concentration, a location within a target frame of the audio signal for a corresponding one of a set of subbands of the target frame, wherein the target frame is subsequent in the audio signal to the frame that is described by the reference frame; and
an encoder configured to encode the set of subbands of the target frame separately from samples of the target frame that are not in any of the set of subbands to obtain an encoded component,
wherein the encoded component includes, for each of at least one of the set of subbands, an indication of a distance in the frequency domain between the selected location for the subband and the location of the corresponding concentration.

29. The apparatus according to claim 28, wherein each among the plurality of concentrations of energy in the reference frame is a peak.

30. The apparatus according to claim 28, wherein said selector is configured to select the location, for each of the set of subbands, from among a plurality of candidates that includes the location of the concentration.

31. The apparatus according to claim 28, wherein the samples of the target frame that are not in any of the set of subbands include samples that are located between adjacent ones of the set of subbands.

32. The apparatus according to claim 28, wherein said apparatus comprises a decoder configured to dequantize an encoded signal to obtain the reference frame.

33. The apparatus according to claim 28, wherein said encoder is configured to perform a gain-shape vector quantization operation on at least one among the set of subbands.

34. The apparatus according to claim 28, wherein the audio signal is based on a linear prediction coding residual.

35. The apparatus according to claim 28, wherein the target frame is a plurality of modified discrete cosine transform coefficients.

36. The apparatus according to claim 28, wherein the encoded component includes, for each of the set of subbands, an indication of a distance in the frequency domain between the selected location for the subband and the location of the corresponding concentration.

37. The apparatus according to claim 28, wherein said selected location includes, for at least one of the set of subbands, a corresponding jitter value.

38. The apparatus according to claim 28, wherein said apparatus comprises a bit packer configured to produce an encoded frame that includes (A) the encoded component and (B) a representation of an ordered series of values of samples of the target frame that are not in any of the set of subbands.

39. The apparatus according to claim 28, wherein said apparatus comprises:
a decoder configured to decode the encoded component to obtain a decoded set of subbands;
a combiner configured to subtract the decoded set of subbands from the target frame to obtain a residual;
a residual encoder configured to encode the residual to obtain an encoded residual; and
a bit packer configured to produce an encoded frame that includes (A) the encoded component and (B) the encoded residual.

40. A non-transitory computer-readable storage medium having tangible features that cause a machine reading the features to:
locate, in a frequency domain, a plurality of concentrations of energy in a reference frame that describes a frame of the audio signal;
for each of the plurality of frequency-domain concentrations of energy, and based on a location of the concentration, select a location within a target frame of the audio signal for a corresponding one of a set of subbands of the target frame, wherein the target frame is subsequent in the audio signal to the frame that is described by the reference frame; and
encode the set of subbands of the target frame separately from samples of the target frame that are not in any of the set of subbands to obtain an encoded component,
wherein the encoded component includes, for each of at least one of the set of subbands, an indication of a distance in the frequency domain between the selected location for the subband and the location of the corresponding concentration.
